(19) United States
(12) Patent Application Publication
(10) Pub. No.: US 2013/0080672 A1
(43) Pub. Date: Mar. 28, 2013

(54) SYSTEM, METHOD AND COMPUTER PROGRAM PRODUCT FOR ACCESS CONTROL

(71) Applicant: KAMINARIO TECHNOLOGIES LTD., Yokne'am ILIT (IL)

(72) Inventors: Doron TAL, Haifa (IL); Gilad CHITRON, Karmiel (IL)

(73) Assignee: KAMINARIO TECHNOLOGIES LTD., Yokne'am ILIT (IL)

(21) Appl. No.: 13/625,212

(22) Filed: Sep. 24, 2012

Related U.S. Application Data
(60) Provisional application No. 61/539,635, filed on Sep. 27, 2011.

(51) Int. Cl. G06F 12/00

(52) U.S. Cl. 710/200

(57) ABSTRACT

An access control system for controlling access to a resources group including multiple computer accessible resources, the system including: a lock, configured to selectively deny a request of a process to access the resource when the resource is locked; and a global lock, configured to grant to the process exclusive access to add a pending-task entry into a resource-associated data structure associated with the resource; wherein the global lock has to be acquired by any process whose request to access any resource of the resources group for performing of any task was denied, in order for access thereto for performing the respective task to be granted; wherein the lock is further configured to selectively grant, following the adding of the pending task-entry into the resource-associated data structure, exclusive access to the resource for performing a task associated with the pending task entry upon a releasing of the resource associated lock.

### FIELD OF THE INVENTION

This invention relates to systems, methods and computer program products for access control.

### BACKGROUND OF THE INVENTION

When multiple processes that can access various resources execute in parallel in a system and wherein some of those processes may attempt to access a single resource in parallel to each other, concurrency control measures are needed in order to prevent potentially harmful concurrent utilization of a resource by multiple processes or threads.

Locks are commonly implemented in order to prevent undesired concurrent access of different processes to a single resource. In order to access a resource in a system in which locks are implemented, each process has to acquire the lock before accessing the corresponding resource. The use of resources may be on an advisory cooperation basis or on a mandatory basis. Locks may be implemented in software, hardware, or firmware.

In environments with multiple resources, an independent lock may be associated with every single resource. However, in prior art applications, the lock overhead is increased substantially with any increase in the amount of locks used in the system. In systems in which the amount of resources and respective locks may well exceed a million resources, the overhead in managing complex locks may be very significant.

For example, in one trivial solution, a mutex is implemented for every block in a mass storage device (or multiple devices) accessible by such multiple processes. However, with mutexes implemented in a 1-1 ratio for a multitude of block size resources, the mutex size was close to the block size.

The memory footprint in such implementations is very large, and presents a barrier on the number of resources that may be effectively implemented in a system. Furthermore, multiple processes trying to synchronize themselves on multiple locks using mutex\semaphore could also be time consuming.

### SUMMARY OF THE INVENTION

In accordance with an aspect of the presently disclosed subject matter, there is provided a method for controlling access to a resources group including multiple computer accessible resources, the method including: (a) receiving a plurality of requests for granting a respective plurality of processes access to at least one resource of the resources group for performing respective tasks; (b) denying a request out of the plurality of requests, when a resource-associated lock of a respective resource is locked; (c) for any process out of the plurality of processes whose request to access a respective resource was denied, attempting to acquire a global lock for the respective process and granting access to the respective resource for performing of the respective task only after the global lock was acquired for the respective process; (d) upon acquisition of a global lock for a process that is associated with the request, granting exclusive access to a resource-associated data structure and adding to the data structure a pending-task entry that is associated with the process; and (e) upon a releasing of the resource associated lock selectively granting exclusive access to the resource for performing a task associated with the pending task entry.

According to an embodiment of the invention, the resource-associated data structure may be a resource-associated queue that is associated with the resource, wherein the selective granting is responsive to a position of the pending-task entry in the resource-associated queue.

The method may further include enqueuing in a global queue a pending-process entry associated with the process, wherein the global queue queues pending-process entries of any process whose request to access any resource of the resources group for performing of any task was denied.

The method may further include attempting to lock the resource by running by the lock an atomic compare-and-exchange operation that includes comparing: (a) a value indicated in a received request to access the resource, and (b) a lock-associated value indicative of the number of pending-task entries in the resource-associated data structure; wherein the a result of the attempting depends on a result of the comparing.

According to an embodiment of the invention, the granting of the exclusive access to add the pending-task entry into the resource-associated data structure may be preceded by attempting to lock the resource for the process, and is selectively carried out only if the attempt failed.

According to an embodiment of the invention, the selective granting of the exclusive access to the resource for performing the task is carried out after a releasing of the global lock by the process.

The method may further include denying a releasing-request of a previously-permitted process to release the locking of the resource when the resource-associated data structure includes non-zero number of pending-task entries, wherein the global lock has to be acquired by any process whose releasing-request to release the locking of any resource of the resources group was denied, in order for the locking to be released.

Additionally, the method may further include: (a) enqueuing in a global queue a pending-process entry associated with the process, wherein the global queue queues pending-process entries of any process whose request to access any resource of the resources group for performing of any task was denied; (b) wherein the selectively granting of the exclusive access to the resource follows a selecting of the pending-task entry from the resource-associated data-structure in response to a position in the global queue of a process-associated entry associated with the previously-permitted process whose releasing request was denied.

According to an embodiment of the invention, the selective granting of the exclusive access to the resource for performing of the task associated with the pending task entry may be followed by executing a function indicated in the pending-task entry.

An access control system for controlling access to a resources group including multiple computer accessible resources, the system including: (a) a lock, configured to selectively deny a request of a process to access the resource when the resource is locked; and (b) a global lock, configured to grant to the process exclusive access to add a pending-task entry into a resource-associated data structure associated with the resource; wherein the global lock has to be acquired by any process whose request to access any resource of the resources group for performing of any task was denied, in order for access thereto for performing the respective task to be granted; wherein the lock is further configured to selectively grant upon a releasing of the resource associated lock exclusive access to the resource for performing a task associated with the pending task entry.

The resource-associated data structure may be a resource-associated queue that is associated with the resource, wherein the lock is configured to selectively grant the access to the resource in response to a position of the pending-task entry in the resource-associated queue.

The system may include a memory for storing a global queue that queues pending-process entries of any process whose request to access any resource of the resources group for performing of any task was denied, wherein a pending-process entry associated with the process may be enqueued in the global queue.

The lock may be an atomic lock that is configured to run an atomic compare-and-exchange operation that includes comparing: (a) a value indicated in a received request to access the resource, and (b) a lock-associated value indicative of the number of pending-task entries in the resource-associated data structure.

The lock may be configured to selectively grant the exclusive access to the resource for performing of the task after a releasing of the global lock by the process.

The lock may be further configured to deny a releasing-request of a previously-permitted process to release the locking of the resource when the resource-associated data structure includes non-zero number of pending-task entries, wherein the global lock has to be acquired by any process whose releasing-request to release the locking of any resource of the resources group was denied, in order for the locking to be released.

Additionally, the global queue may further queue pending-process entries of any process whose request to access any resource of the resources group for performing of any task was denied; wherein the lock is further configured to selectively grant the exclusive access to the resource, following a selecting of the pending-task entry from the resource-associated data-structure, in response to a position in the global queue of a process-associated entry associated with the previously-permitted process whose releasing request was denied.

The system may include a processor that is configured to execute, following the selective granting by the lock of the exclusive access to the resource for performing the task associated with the pending task entry, a function indicated in the pending-task entry.

A program storage device readable by machine, tangibly embodying a program of instructions executable by the machine to perform method for controlling access to a resources group including multiple computer accessible resources, including the steps of: (a) receiving a plurality of requests for granting a respective plurality of processes access to at least one resource of the resources group for performing respective tasks; (b) denying a request out of the plurality of requests, when a resource-associated lock of a respective resource is locked; (c) for any process out of the plurality of processes whose request to access a respective resource was denied, attempting to acquire a global lock for the respective process and granting access to the respective resource for performing of the respective task only after the global lock was acquired for the respective process; (d) upon acquisition of a global lock for a process that is associated with the request, granting exclusive access to a resource-associated data structure and adding to the data structure a pending-task entry that is associated with the process; and (e) upon a releasing of the resource associated lock selectively granting exclusive access to the resource for performing a task associated with the pending task entry.

The resource-associated data structure may be a resource-associated queue that is associated with the resource, wherein the instructions tangibly embodied in the program storage device for selective granting, include instructions for selective granting of exclusive access to the resource, in response to a position of the pending-task entry in the resource-associated queue.

The program instructions tangibly embodied in the program storage device may further include instructions for enqueuing in a global queue a pending-process entry associated with the process, wherein the global queue queues pending-process entries of any process whose request to access any resource of the resources group for performing of any task was denied.

The program instructions tangibly embodied in the program storage device may further include instructions for attempting to lock the resource by running by the lock an atomic compare-and-exchange operation that includes comparing: (a) a value indicated in a received request to access the resource, and (b) a lock-associated value indicative of the number of pending-task entries in the resource-associated data structure; wherein the a result of the attempting depends on a result of the comparing.

The granting of the exclusive access to add the pending-task entry into the resource-associated data structure may be preceded by attempting to lock the resource for the process, and is selectively carried out only if the attempt failed.

The instructions for the selective granting of the exclusive access to the resource for performing the task may include instructions for carrying out the selective granting after a releasing of the global lock by the process.

The program instructions tangibly embodied in the program storage device may further include instructions for denying a releasing-request of a previously-permitted process to release the locking of the resource when the resource-associated data structure includes non-zero number of pending-task entries, wherein the global lock has to be acquired by any process whose releasing-request to release the locking of any resource of the resources group was denied, in order for the locking to be released.

Additionally, the program instructions tangibly embodied in the program storage device may further include instructions for enqueuing in a global queue a pending-process entry associated with the process, wherein the global queue queues pending-process entries of any process whose request to access any resource of the resources group for performing of any task was denied; wherein the selectively granting of the exclusive access to the resource follows a selecting of the pending-task entry from the resource-associated data-structure in response to a position in the global queue of a process-associated entry associated with the previously-permitted process whose releasing request was denied.

The program instructions tangibly embodied in the program storage device may further include instructions for executing a function indicated in the pending-task entry after the selective granting of the exclusive access to the resource for performing of the task associated with the pending task entry.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram of system for controlling access to multiple computer accessible resources, according to an embodiment of the invention;

FIG. 2 is a flowchart of an implementation of an atomic compare and exchange (ACE) lock, according to an embodiment of the invention;

FIG. 3 is a flow chart of a method for attempting to lock a resource, according to an embodiment of the invention;

FIG. 4 is a flow chart of a method for attempting to unlock a resource, according to an embodiment of the invention;

FIG. 5 illustrates different states of some components of the system of FIG. 1 during its operation, according to an embodiment of the invention;

FIG. 6A is a flow chart of a method for controlling access to a resources group including multiple computer accessible resources, according to an embodiment of the invention;

FIG. 6B is a flow chart of a method for controlling access to a resources group including multiple computer accessible resources, according to an embodiment of the invention;

FIG. 7 is a flow chart of a method for controlling a releasing of a locking on a resource that is a member of a resources group that includes multiple computer accessible resources, according to an embodiment of the invention; and

FIGS. 8A and 8B illustrate access control of multiple resources, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as processing, “determining”, “generating”, “updating”, “selecting”, or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

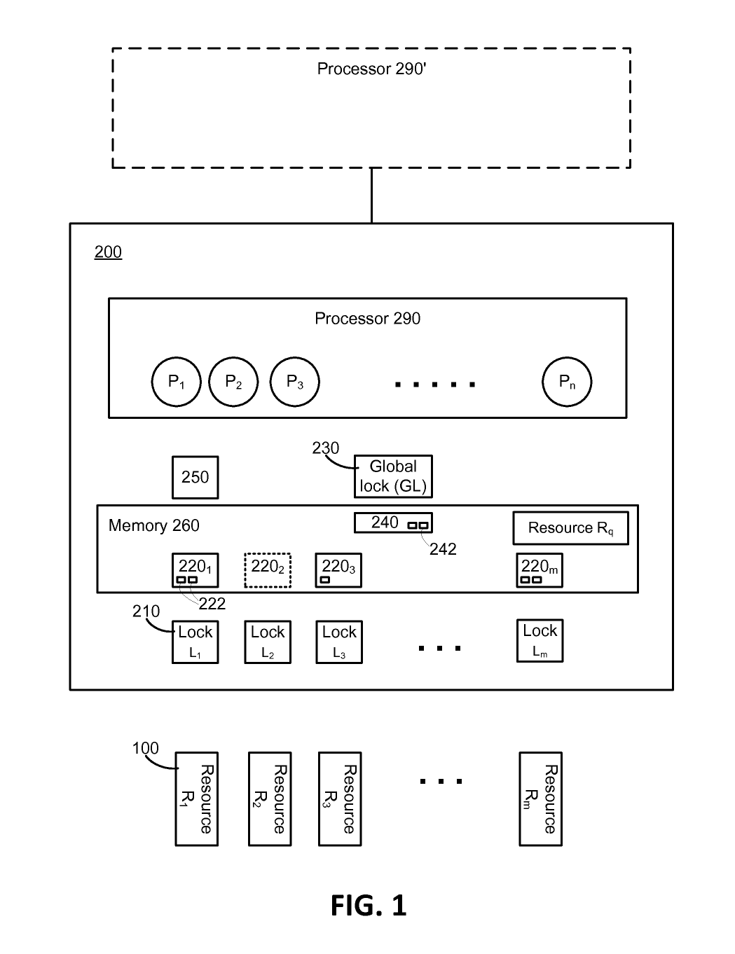

FIG. 1 is a block diagram of system 200 for controlling access to multiple computer accessible resources 100 (denoted 100(1) through 100(n)) of a resources group 10, according to an embodiment of the invention. It is noted that some or all of the resources 100 of the group 10 may be part of system 200, but this is not necessarily so, and some or all of the resources 100 may be auxiliary to system 200, and even located remotely therefrom.

For example, such resources 100 may be storage resources (e.g. a magnetic disk, a flash drive, random access memory (RAM), or defined portions thereof), communication resource (e.g. I/O component of system 200, not illustrated), and so forth. It should be noted that not all of the resources accessible by system 200 and/or component thereof (or by any external system whose access to resources is controlled by system 200) necessarily belong to the group of resources 10, and are not necessarily controlled by system 200. As will be demonstrated below, according to some embodiments of the invention system 200 may control access to resources 100 of multiple groups 10, but even then not all of the aforementioned accessible resources would necessarily belong to any of the groups 10.

System 200 may be implemented in various types of computer systems according to various embodiments of the invention. In but a few examples, system 200 may be implemented in a personal computer, in a storage server, in a storage management computer, in a computer of a communication device or component, and so forth. It is noted that system 200 may be implemented on a main processor of such a computer (e.g. on its central processing unit), but may also be implemented otherwise—e.g. on a processor dedicated to a specific task in that computer, and on a processor dedicated to the controlling of access to resources. In cases where that system 200 includes several parallel processors or cores (e.g. a multi-core processor), implementations of system 200 may be implemented on one, some, or all of the parallel processors or cores, according to different embodiments of the invention.

Since system 200 operates in an environment where there are many processes executing in parallel, locks 210 are implemented in that environment in order to prevent undesired concurrent access of different processes (or of different threads) to a single resource 100. It is noted that in some embodiments of the invention, some instances of concurrent access of different processes or threads may be permitted, while other instances may be undesired. For example, in some embodiments of the invention, concurrent reading from a storage resource 100 may be permitted, but neither concurrent reading and writing, nor concurrent readings, from that storage resource 100.

Some or all of the locks 210 may be implemented as part of system 200 (for example as illustrated in FIG. 1, e.g. on a processor thereof, and possibly even on the processor that runs the processes whose access to the resources 100 is controlled), but this is not necessarily so. The locks 210 may be implemented in different ways (e.g. software, hardware, and firmware) in different embodiments of the invention, and in some embodiments of the invention the locks 210 associated with the different resources of the group 10 may be of different types (e.g. some hardware locks and some software locks).

In some embodiments of the invention, each lock 210 may be associated with a single resource 100 of the group (e.g. as exemplified in FIG. 1). It is however noted that in other embodiments of the invention, some or all of the locks 210 may be associated with more than one resource 100 each. In such embodiments of the invention, it should be noted that each group of resources 100 lockable by a single lock 210 may be equivalent (where appropriate) with a single resource 100 lockable by a single lock 210 in the following description.

In some embodiments of the invention, some or all of the locks 210 may be advisory locks, where each process or thread cooperates by acquiring the respective lock 210 before accessing the corresponding resource 100. In some embodiments of the invention, some or all of the locks 210 may be mandatory locks preventing unauthorized access to a locked resource 100 (e.g. by forcing an exception in the entity attempting to make the access).

According to an embodiment of the invention, the locks 210 (or at least some of them) are locks that may check a locking status of the lock and to change it in a single uninterruptable (“atomic”) operation. Such locks are commonly referred to as “atomic locks”, and this term will be used in this sense in this disclosure. Instructions that may be used for such atomic locks are, for example, “test-and-set”, “fetch-and-add”, “compare-and-swap” instructions. Such instructions may be used, for example, to test if a lock 210 is free and—if free—acquire the lock 210, in a single atomic operation. Since the checking of the status of the lock 210 and its locking (if allowed) is carried out in such a single uninterruptible operation, processes or threads other than the one which requested the locking are unable to carry any other operation with the lock 210 (especially querying its status or requesting its locking) before the sequence of requesting and locking (if allowed) is completed. Thus, errors which may arise from such scenarios are avoided.

It is noted that atomic locks may be implemented in hardware, in software and in firmware. Especially, the atomic locks if implemented as locks 210 may be hardware atomic locks with are implemented as part of the one or more processors which run the process or threads that may request access to the resources 10 of resources group 10.

Assets—whether physical or virtual—may be divided into a multitude of lockable, distinctively requested resources in many ways. For example, a single lock may be used to lock an entire given hardware mass storage device (e.g. flash drive, a Dynamic random-access memory—DRAM, etc.), but in other implementations different locks may be used to lock parts of such a mass storage device, in differing resolutions—e.g. a lock for each sector, for each block, etc. In an example in which the asset is a virtual database management system, a lock could protect part of a field, a field, a record, a data page, an entire table, and so forth. The way each physical or virtual asset is divided into lockable, distinctively requested resources depends on many factors.

One of the factors which often effect the decision of the granularity of the lock dispersion is the tradeoff between increasing lock overhead and increasing lock contention when choosing the number of locks for each such asset. The greater the amount of locks used for each asset, the lesser is the likelihood that a single resource 100 will be requested by different processes or threads. However, in prior art applications, the lock overhead is increased substantially with any increase in the amount of locks used for each asset. Since the more coarse the locking granularity, the higher the likelihood that the lock will stop an unrelated process or thread from proceeding, fine granularity (a larger number of locks, each protecting a fairly small resource) is preferred many a time.

It is noted that the present system may be implemented in an environment which implements fine granularity and/or a great deal of assets, so that a very large number of locks is implemented. For example, the number of locks may well exceed 100,000 and 1,000,000 locks. As is exemplified below, the system disclosed (as well as method and computer program product) enables utilization of such a large number of locks while limiting the overhead required (e.g. an overhead of storage space, an overhead of computational power). For example, if a lock is implemented for each 4 Kb block in a DRAM, 4 GB of storage space would require some 1,000,000 locks. As the system may be implemented for storages much larger than 4 GB, clearly the number of locks may well exceed a million.

Especially when the number of locks is very large—but not only in such implementations—the number of running processes may be relatively small. For example, if some 1,000,000 locks are implemented, and as many as 1,000 processes or threads are running concurrently, the ratio between the number of concurrent processes/threads that may access the different resources 100 to the number of locks 210 used to limit access to those resources 100 is still 1·10³.

In such implementations, the likelihood of contention (which occurs whenever one process or thread attempts to acquire a lock held by another process or thread) is relatively very low. As is demonstrated below, the overhead (e.g. time, memory, and computational power) required in successful attempts (i.e. when a requested resource 100 is not locked) in system 200 may be substantially lower than the overhead required in contention situations. However, due to the low likelihood of contentions in at least such implementations (when the number of locks exceeds by far the number of concurrently running processes/threads), the relatively higher overhead required in contention situations is not required often, and the average overhead is relatively low.

It should be noted that the utilization and implementations of systems as herein described is nevertheless not limited to environments in which the number of locks well exceeds the number of concurrently running processes, and such systems may be implemented effectively in systems in which the ratio between those numbers differs substantially to the above discussed example.

When each of the locks 210 in system 200 is locked, other processes or threads are prevented from accessing the respective resource 100 associated with that lock (either on an advisory basis in which cooperation of such a process or thread is required and expected, or on a mandatory basis in which unauthorized access by such a process or thread is prevented, e.g. by forcing a respective exception in attempting entity). For each of the locked resources at any given moment (if at all present in that moment) there is a distinct resource-associated data structure 220 that is associated with that resource 100, and which may include one or more pending-task entries 222, a single entry 222 for each task for which access to that respective resource 100 was requested by a process or a thread.

By way of example, the resource-associated data structure 220 may be a resource-associated queue, in which pending-task entries 222 are ordered by the time in which those different entries 222 are enqueued in the resource-associated queue, and access to the respective resource 100 is granted according to the order of the pending-task entries 222. However, this is not necessarily so and other selection rules may be used for selecting pending-task entries 222 from the (ordered or not) resource-associated data structure 210, such as priority based, random, weighted time and priority, FIFO, and so forth. For example, pending-task entries 222 may be selected according to a priority associated with the requesting process or thread associated with that pending-task entry 222.

According to an embodiment of the invention, the resource-associated data-structure 220 is not maintained at all times, and may be generated only when required (e.g. when at least one pending-task entry 222 is included therein). According to an embodiment of the invention, the memory used by the resource-associated data-structure 220 may be dynamically allocated to it, so that the amount of memory allocated thereto is limited to what is needed at different times.

According to an embodiment of the invention, the proposed locking mechanism may be implemented as having a memory footprint as low as 8 bytes (or less) per block (in an example in which each of some or all of the resources 100 is a block in a mass storage device). Such an implementation is usually also very fast in its good-case scenario path (i.e. when there is no contention).

For example, considering n processes (or threads) that are run concurrently (denoted P₁ through Pₙ) and a plurality of m resources 100 denoted resources 100(1) through 100(m). Each of the resources 100 may be accessed by a plurality of the processes P₁ through Pₙ, and possibly by all of them.

It should be noted that the terms “process” and “thread” both refer to instances of processing that can be executed in a computerized system. These terms may have somewhat different meanings in different contexts, but generally the term “process” may be considered to refer to an instance of a computer program that is being executed, while the term “thread” may be considered to refer to a smaller unit of processing that can be scheduled by such an operating system (possibly to the smallest unit that can be scheduled by such operating systems), and may result from a fork of a computer program into two or more concurrently running tasks. In many cases, a thread is contained inside a process, and multiple threads may exist within the same process and share resources such as memory, while different processes do not share these resources. For matter of convenience, the term “process” is used occasionally throughout the text without referring to threads as well. It should however be noted that threads may also be implemented even if only processes are explicitly mentioned. In some embodiments of the invention resources 100 of the group 10 may be accessed only by a process, in other embodiments those resources 100 may be accessed only by threads, and in yet other embodiments of the invention the resources 100 of the group 10 may be accessed by both processes and threads. It would be clear to a person who is of skill in the art that implementation for threads may be easily achieved once implementation for processes is implemented, and vice versa.

As aforementioned, when a process would like to access a resource 100, it needs to acquire a lock 210 on the resource 100 which gives it exclusive access to that resource 100. Any other process which would like to have access to that resource 100 cannot access the resource 100 until the resource 100 is freed from locking (especially by the current locking process, but possibly also be other processes locking it prior to that process). The order in which resources 100 is locked for the carrying out of the different tasks for which different processes request access to a resource 100 is determined according to selecting of respective pending-task entries 222 from the resource-associated data-structure 220 associated with that resource (according to one or more selection rules).

A process or thread that was denied access to resource 100 when the resource was locked does not however unconditionally add a pending-task entry 222 to the respective resource-associated data-structure 220. In different embodiments of the invention, this is ensured on an advisory basis in which cooperation of such a process or thread is required and expected, and may also be ensured on a mandatory basis in which unauthorized access to the respective resource-associated data-structure 220 by such a process or thread is prevented, e.g. by forcing a respective exception in the attempting entity.

In order to add a pending-task entry 222 to the respective resource-associated data-structure 220, the requesting process or thread has to previously acquire global lock 230. Notably, the global lock 230 has to be acquired by any process whose request to access any resource 100 of the resources group 10 for performing of any task was denied, in order for access thereto for performing the respective task to be granted.

It should be noted that more than one global lock 230 may be implemented. For example, a set of R global locks 230 may be implemented and for each lock 210 Lq, lock[q mod 10] may be used. However, in such an implementation, each group of global lock 230 and its corresponding locks 210 may be considered as belonging to an independent system 200. In such case, some of the components (e.g. processor 290, memory 260) may be shared between several such systems 200.

The global lock 230 may be implemented in different ways (e.g. software, hardware, and firmware) in different embodiments of the invention. In different embodiments of the invention, the global lock 230 may be implemented in different ways, e.g. as an atomic lock, as a spin lock, as a mutex, as a semaphore, and so forth. The requirement of acquisition of the global lock 230 may be enforced mandatorily and may be enforced advisorily, e.g. as exemplified above.

While not necessarily so, a global data-structure 240 may be implemented, for storing pending-process entries 242 associated with processes that await to acquire the global lock 230. The global data-structure 240 may be implemented, if at all implemented, as a queue, but this is not necessarily so, and other (ordered or unordered) data-structures may be implemented, such as a linked-list, a table, a heap, and so forth. The pending-process entries 242 may be implemented differently in different embodiments of the invention, and may include, for example, an identifier of the process, a pointer to the process and/or to a location accessible by which, a pointer to a function that should be carried out when the respective entry is selected (e.g. for calling the process) or other indication of such a function, and so forth.

Global data-structure 240 is not necessarily implemented, especially as the waiting time for the global lock 230 in at least some embodiments of the invention may be relatively very short. The relatively short time of waiting in such embodiments of the invention may arise, for example, from a low rate of contention in the locks 210, and from the relatively short time for which processes need to acquire the global lock 230, e.g. as disclosed below. Other mechanisms that may be implemented, for example, are simply recurrent attempting to acquire the global lock 230 by processes or threads awaiting it, e.g. after waiting a randomly (or pseudo-randomly, or priority-based, etc.) selected amount of time, which may differ from process to process.

When a previously denied (by a lock 210) process acquires the global lock, it is granted exclusive access to add a pending-task entry 222 into a resource-associated data structure 220 associated with the resource 100 for which access was previously denied by that lock 210. However, according to some embodiments of the invention, this previously denied process does not immediately add a corresponding pending-task entry 222 to the respective resource-associated data-structure 220, but priorly attempts to lock the resource 100 once again (by attempting to acquire the respective lock 210). If successful, this process would release the global lock in response.

It is noted that from the time that the process was denied access to the resource 100 because the latter was locked until the time it acquired the global lock, the previously locking processes may have ended its task with the resource, and have released the locking on that lock. In such cases, it may not be necessary to add a pending-task entry 222 to the resource-associated data-structure 220.

According to some embodiments of the invention, a contention status may be associated with each of the resources 100 (or at least with the locked ones among them), which may indicate how many processes, or tasks, are waiting for the resource 100 (e.g. how many pending-task entries 222 are included in the associated resource-associated data-structure 220). According to other embodiments of the invention, the contention lock may not indicate an exact number of waiting processes, or tasks, but otherwise indicate a status of the lock 210 (e.g. locked/unlocked) or of its contention status (e.g. no pending tasks/one task is pending/more than one task is pending). In embodiments of the invention in which the contention status indicates the number of the waiting processes or tasks, this number may and may not include the process which currently locks the resource 100.

According to an embodiment of the invention, upon acquisition of the global lock 230 by the process, the contention status associated with the resource 100 may be updated (e.g. by that process—such as due to exclusive contention status access granted to it, or by other entity, such as a locks manager—not illustrated). The updating may done by increasing a number that is stored in the contention status (and/or indicated by it) by one.

Once the process that acquired the global lock acquired the lock 210 or added a respective pending-task entry to the resource-associated data-structure 220 (in both cases the contention status, if implemented, may be updated), it can release the global lock 230, which may then be acquired by another process (which either waits for the global lock 230, or attempts to acquire it at a later time in case no other processes are currently waiting for the global lock 230).

When the locking process that locks a locked resource 100 concludes its task that utilizes that resource, a pending-task entry 222 may be selected from the respective resource-associated data-structure 220 (according to the one or more selection rules applied), and access to the resource 100 may be granted according to the result of the selection. The role of selecting the next pending-task entry 222—or at least the initiation of such selection—may be assigned to the locking process that concluded its task, but may also be assigned to another entity (such as a locks manager).

As is discussed below in further detail, the concluding process or thread does not necessarily release the locking, as—according to some embodiments of the invention, this process may carry out a task indicated in the selected pending-task entry 222. In this way, some or all of the processes that add pending-task entries 222 to one or more resource-associated data-structures 220 are not required to wait until the respective resource 100 is free, and may continue with other tasks, counting on another process (not necessarily a previously identified one) to pick up the task and conclude it.

However, the previously locking process may also release its locking of the resource 100, enabling another process to lock that resource 100.

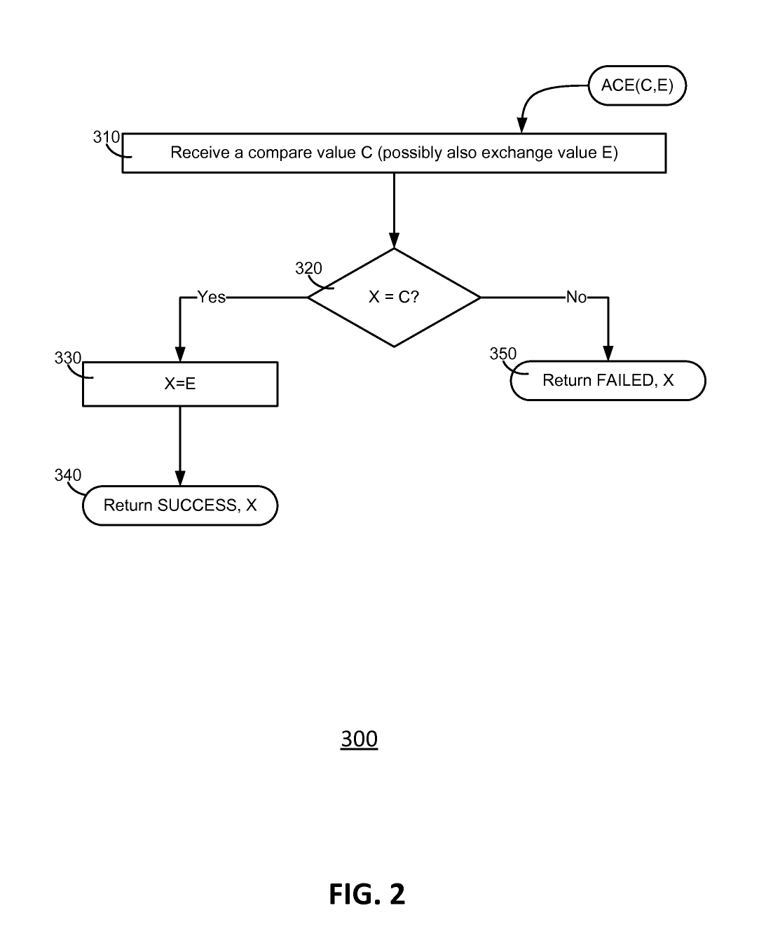

FIG. 2 is a flowchart of an implementation of an atomic compare and exchange (ACE) lock, according to an embodiment of the invention. The implementation illustrated in FIG. 2 may be implemented by any one or more of the locks 210, but this is not necessarily so.

In stage 310 the lock receives a request that includes a compare value (denoted C) and may also include an exchange value (denoted E). The compare value C is the value that if equal to a lock-associated value (denoted X) associated with lock (e.g. the lock-associated value may be the aforementioned contention-status), the requesting process will get the lock. The lock-associated value X may be stored internally within the lock, but this is not necessarily so.

By way of example, the lock-associated value X may be the number of processes actively locking and waiting for the lock (e.g. equal to the number of the pending-task entries in an associated resource-associated data structure, for example in an associated queue). It is noted that, in some embodiments of the invention, the lock-associated value X may be determined as the length of that resource-associated data structure plus one, and therefore storing of the lock-associated value X independently may not be required. It should be noted that according to other embodiments of the invention, the lock-associated value X may not pertain to the resource-associated data-structure or to the number of entries in it. For example, in some implementations the resource may not be locked even when there are pending tasks waiting for the resource (e.g. in some implementations in which the process previously locking the resource has just released the locking), in which case the lock-associated value X may and may not mean that the lock may be granted to a requesting process and not to according to a pending-task entry, depending on the specific implementation.

In stage 320 the lock-associated value X is compared against the compare value indicated in the request received by the lock. If they are equal (YES in stage 320) then the process may get the lock, in stage 340 in which a SUCCESS value is sent back to the process. Before the success value is sent to the requesting process (or, in other embodiments of the invention, after or concurrently with the sending), the lock-associated value may be updated to another value in stage 330. The updating may include replacing the lock-associated value X with the exchange value E if included in the request (as illustrated in FIG. 2), but may also include updating the lock-associated value to another value (e.g. selected by the lock, for example in case in which the request does not include an exchange value).

If the compare value C and the lock-associated value X are not the same (NO in stage 320), then instead of being followed by stage 340 and/or 330, stage 320 is followed by stage 350 in which a FAILED value is sent back to the process, indicating that the request is denied (possibly accompanied by the current lock-associated value X).

For example, if the lock-associated value X is indeed an indicating of the number of locking processes (e.g. either 1 or 0)—either as such or added with the number of entries in the associated queue (or other data-structure), then the request may include (C,E)=(0,1). Therefore, in case no process locking the resource (and possibly no pending task either) then X=0, and therefore in stage 320 X=C results in a positive answer, which results in updating X=1 and SUCCESS value being sent to the process. Continuing the same example, if on the other hand the resource is locked, then X≧1, therefore the check “X=C?” results in a negative answer, which results in sending a FAILED value back to the requesting process.

It is noted that according to an embodiment of the invention, each sequence of stages 320 through 340 and each instance of stage 320 and 350 (whichever is carried out for each given requesting process) are carried out in an uninterruptible atomic operation.

It is further noted that locks 210 in system 200 and/or in the environment thereof may operate in accordance with method 300, but this is not necessarily so.

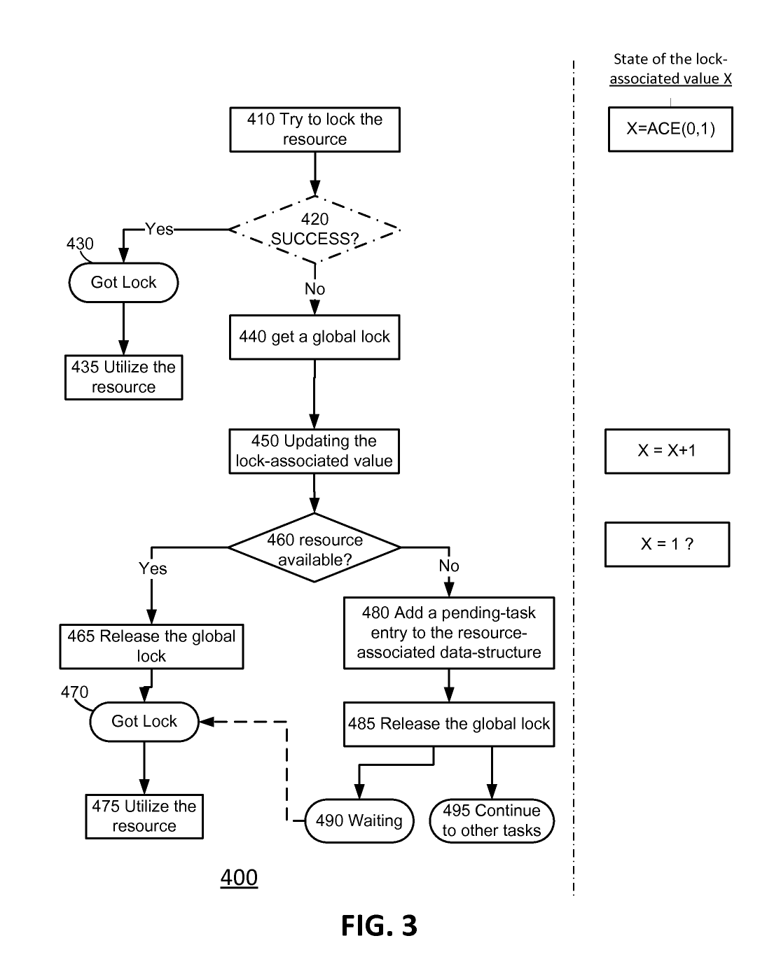

FIG. 3 is a flow chart of method 400 for attempting to lock a resource, according to an embodiment of the invention. According to an embodiment of the invention, method 400 may be carried out by any requesting process in system 200 (e.g. a process run by processor 290, and/or by an external processor 290′, if implemented). The flowchart of FIG. 3 may be used to describe a TRY-LOCK action performed by some process against a lock trying to gain access to a resource lockable by that lock, according to an embodiment of the invention. According to an embodiment of the invention, when any process needs exclusive access to the resource, it tries to lock the associated lock. Referring to the examples set forth in the previous drawings, method 400 and/or any combination of its stages may be carried out by a process, e.g. by a processor running that process, such as processor 290.

In stage 410, the process tries to lock the resource (or otherwise request access to the resource). The process may issue a request to lock the resource that may be implemented as a request for an atomic compare-and-exchange operation (ACE, potentially implementable as a “compare-and-swap” or a “compare-and-set” operation), e.g. as exemplified in relation to method 300, and especially to stage 310. The request may include, for example, a compare value (denoted C) and may also include an exchange value (denoted E).

The compare value C is the value that if equal to a lock-associated value (denoted X) associated with lock (e.g. the lock-associated value may be the aforementioned contention-status), the requesting process will get the lock. The exchange value E is the value to which the lock-associated value X is updated. In other embodiments, the exchange value may be omitted. According to an embodiment of the invention, both the compare value C and the exchange value E (if implemented) may pertain to the lock-associated value X (and/or to the contention status) which indicates the amount of pending-task entries pending in a resource-associated data-structure associated with the resource.

Stage 420 may include an attempt to lock the resource which may be implemented by running an atomic compare-and-exchange operation (ACE, potentially implementable as a “compare-and-swap” or a “compare-and-set” operation) by the lock, e.g. with values C=0 and E=1. In some embodiments this will test if the lock is free and its associated resource-associated data-structure is empty. If implemented as an ACE request, the parallel status in the lock is that the lock-associated value X is determined as a result of the ACE(0,1) operation (e.g. as discussed in relation to method 300). Referring to the examples set forth in the previous drawings, stage 410 may include attempting to lock a resource 100 by trying to get an associated lock 210.

If the attempt to lock the resource is successful (denoted as YES in 420 of the drawing) then in stage 430 the process will receive a GOT-LOCK value (e.g. the SUCCESS value of method 300). The process then may utilize the resource (e.g. by reading from it, writing to it, using it for communication, and so forth), denoted as stage 435.

If the locking attempt (e.g. the ACE operation) on the lock fails (denoted as NO in 420 of the drawing) then in stage 440 the process will get a global lock (if the global lock is already taken, it will wait for it, and may also queue for it or otherwise register in a global data-structure associated with that global lock). Referring to the examples set forth in the previous drawings, stage 440 may include getting global lock 230. It is noted that the global lock is the only global lock associated with the resource (and with its associated lock whose locking was attempted at stage 410), and is possibly shared by a group of locks used for the locking of multiple resources.

Once the global lock is locked, in optional stage 460 the process will check if the resource is available for locking. This may be carried out, for example, by checking a value of a contention status and/or the lock-associated value X, but may also be carried out as another request to the lock. For example, stage 460 may include determining whether the lock-associated value X indicates that the lock is currently not locked (e.g. by checking whether X=1? if previously updating the lock-associated value X in previous stage 450). It should be noted that components and stages that are disclosed as “optional” may be mandatory in some implementations, not implemented at all in other implementations, and indeed optional in some implementations.

Stage 460 may be preceded by stage 450 of updating (or instructing an update of) the lock-associated value X and/or the contention status. It is noted that in some embodiments of the invention, both lock-associated value X and contention status may be used. For example, one of these values may be used to indicate whether the resource is locked or not (and may be a binary value, for example), while the other may be used to indicate the number of pending-task entries in the lock-associated data-structure (possibly added with the locking process). For example, the updating of stage 450 may include increasing the lock-associated value by one (X=X+1) and/or modifying the contention status associated with the resource from available (or “unlocked”) to unavailable (or “locked”). It is noted that stage 450 may also be carried out after stage 460 or concurrently to which, in other embodiments of the invention.

According to an embodiment of the invention, stage 450 is carried out in a single atomic operation. According to an embodiment of the invention, stage 450 and 460 are carried out together, in an atomic uninterruptable operation (wherein updating of the lock-associated value X may follow, if locking is denied).

If a result of stage 460 is that the resource is available for locking (denoted as YES in 460) by the requesting process (and possibly unavailable to locking by other processes—because the lock-associated value X and/or the contention status were updated previously), then in stage 470 the process will receive a GOT-LOCK value (e.g. the SUCCESS value of method 300). The process than may utilize the resource (e.g. by reading from it, writing to it, using it for communication, and so forth), denoted as stage 475. The positive result of stage 460 is also followed by stage 465 of releasing the global lock by the process. Stage 465 may precede stage 470 and may follow it. The releasing of the global lock would however occur before the utilization of the resource in stage 475, because the global lock is required only until the getting of the lock that locks the resource (or, as will be demonstrated below, for adding an entry to a resource-associated data-structure).

If a result of stage 460 is that the resource is unavailable for locking (denoted as NO in 460) by the requesting process (e.g. because it is currently locked by another process and/or because another one or more processes is waiting for the resource), then in stage 480 the process will add (or instruct an adding) a pending-task entry to a resource-associated data-structure associated with the resource. Following the adding of the pending-task entry, the process will release the global lock in stage 485. Referring to the examples set forth in the previous drawings, stage 480 may include adding the pending-task entry to a resource-associated data-structure such as resource-associated data-structure 220. According to an embodiment of the invention, the resource-associated data-structure may be a resource-associated queue, but this is not necessarily so.

Stage 480 is preceded by granting the process exclusive access to add the pending-task entry into the resource-associated data structure associated with the resource. It is noted that the granting may be implemented as a confirmation sent to the process as to the acquisition of the global lock (e.g. a SUCCESS value sent to it when it acquires the global lock). In other embodiments, the granting may be also be implemented by the lock itself, or by an associated entity. In some embodiments, an advisory basis granting may be implemented in which the process restricts itself from adding the pending-task entry to the resource-associated data-structure before it acquires the global lock.

It should be noted that, according to an embodiment of the invention, the resource-associated data-structure does not exist if there are currently no pending-task entries that await for the lock. Therefore, according to an embodiment of the invention, the adding of stage 480 may be preceded by checking if a respective resource-associated data-structure exists (or is active), and if not, by creating a respective resource-associated data-structure. The creating may be carried out by the process, by the lock, by an entity associated with the lock, and/or by an entity associated with multiple locks (e.g. a locking manager).

Once the pending-task entry is added to the resource-associated data-structure, the process may wait for an indication that it may get the lock (e.g. due to some selection rule applied for selecting pending-task entries from the resource-associated data-structure) as shown in stage 490, and may possibly also return a WAIT value. Once receiving an indication that it may get the lock, the process may cease waiting and get the lock, thereafter utilizing the resource (e.g. for performing its original task).

According to an embodiment of the invention, when the respective pending-task entry will be selected from the resource-associated data-structure, access may be granted for performing of the task associated with the pending task entry (e.g. in stage 470). The selecting may be carried out when a previously locking process unlocks the resource. According to an embodiment of the invention, the selecting of the pending-task entry from the resource-associated data-structure is carried out in response to a position in the global queue of a process-associated entry associated with a previously-permitted process whose releasing request was denied (e.g. in stage 520 of method 500).

Alternatively, the process may not wait until the respective pending-task entry is selected from the resource-associated data-structure. In some embodiments of the invention, the process may in stage 495 turn to other tasks (or, alternatively, wait until other tasks are due or even end). According to an embodiment of the invention, when the respective pending-task entry is selected, another process (e.g. the process that just finished with the resource) carries out the task indicated in the pending-task entry or in another location pointed to in the pending-task entry.

In an example, at stage 460 it is determined if the lock-associated value X is equal to 1. If it is (YES in stage 460), then X was equal to 0 prior to the increase of stage 450 (which in such an implementation means that no other process waits or holds the lock) and therefore it will release global lock in stage 465 and a GOT-LOCK will be returned in stage 470. Continuing the same example, if the value of the lock-associated value X is greater than 1 (NO in stage 460), then X was greater than 0 prior to the increase of stage 450 (which in such an implementation means that at least one process waits or holds the lock) and therefore in stage 480 the process will enter a pending-task entry to the resource-associated data-structure (which may be, for example, the lock's waiting queue), release the global lock in stage 485 and will return a WAIT value in stage 490.

In different embodiments of the invention, the pending-task entries added to the resource-associated data-structure may be implemented in different ways—pertaining both to system 200 and to method 400 and to the methods discussed below. In some embodiments of the invention, the pending-task entries (e.g. pending-task entries 222) may include, for example, an identifier of the process adding them to the resource-associated data-structure, a pointer to the process and/or to a location accessible by which, a pointer to a function that should be carried out when the respective entry is selected (e.g. for calling the process), and so forth.

Such a function may be implemented in various ways, and even in different ways by different processes in a single implementation. For example, the selection of the pending-task entry from the resource-associated data-structure may be followed by carrying out of the function pointed to in the pending-task entry and which may be stored, for example, in a dedicated database, look-up-table, etc. The function, upon its execution, may perform various tasks such as any one or more of the following: indicating to the process that the pending-task entry was selected (e.g. allowing it to perform the task or delegate it to another thread or process), indicating to another process (e.g. the process currently finished utilizing the resource) which task it should perform (content of such a task—e.g. material to be written to a mass-storage device—may be stored in another database and may include further instructions).

It should be noted that method 400 may be reiterated for several processes and possibly also for several locks. The corresponding stages in any such two or more reiterations are not necessarily carried out in an orderly fashion. For example—if a first process added a pending task-entry to the resource-associated data-structure in stage 480 of a first iteration before a second process has done so in a second iteration, the second process may nevertheless receive the lock on the resource (at stage 470, following the waiting of stage 490) in some situations, before the first process gets it. This may be so even if these processes added their pending-task entries to the same resource-associated data-structure (i.e. they both requested access to the same lock).

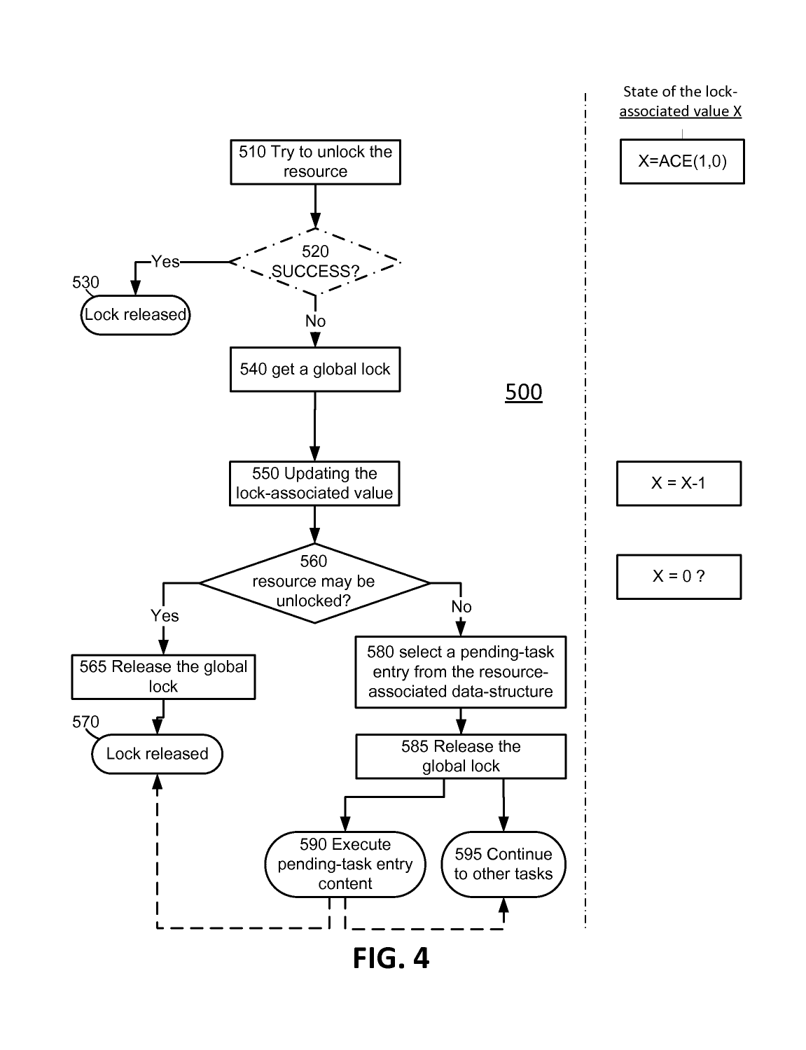

FIG. 4 is a flow chart of method 500 for attempting to unlock a resource, according to an embodiment of the invention. According to an embodiment of the invention, method 500 may be carried out by any process that attempts to release its locking of a resource 100 in system 200 (e.g. a process run by processor 290, and/or by an external processor 290′, if implemented). For example, the process may be a process previously permitted to access the resource when the resource was not locked by another process.

The flowchart of FIG. 4 may be used to describe a TRY-UNLOCK action performed by some process against a lock trying to relinquish access to resource lockable by that lock, according to an embodiment of the invention. According to an embodiment of the invention, when any process attempts to release its locking of the resource, it tries to unlock the associated lock according to method 500. Referring to the examples set forth in the previous drawings, method 500 and/or any combination of its stages may be carried out by a process, e.g. by a processor running that process, such as processor 290.

Method 500 may be implemented together with method 400—so that attempts of locking locks (especially locks that control access to the resources of a given resources group) are carried out according to method 400 and attempts of unlocking those locks are carried out according to method 500. However, this is not necessarily so. For example, in an implementation in which locks are locked according to method 400, those locks may be unlocked other than according to method 500, and in an implementation in which locks are unlocked according to method 500, those same locks may be previously locked other than according to method 400.

In stage 510, the process tries to unlock the resource currently locked by the process. The process may issue a request to unlock the resource (that may also be referred to as a releasing request) that may be implemented as a request for an atomic compare-and-exchange operation (ACE, potentially implementable as a “compare-and-swap” or a “compare-and-set” operation). The request may include, for example, a compare value (denoted C) and may also include an exchange value (denoted E). The compare value C is the value that if equal to a lock-associated value (denoted X) associated with lock (e.g. the lock-associated value may be the aforementioned contention-status), the requesting process may be permitted to release its locking on the resource. The exchange value E is the value to which the lock-associated value X is updated. In other embodiments, the exchange value may be omitted. According to an embodiment of the invention, both the compare value C and the exchange value E (in implemented) may pertain to the lock-associated value X (and/or to the contention status) which indicates the amount of pending-task entries pending in a resource-associated data-structure associated with the resource.

Stage 510 may include an attempt to unlock the resource that may be implemented by running an atomic compare-and-exchange operation (ACE) by the lock, e.g. with values C=1 and E=0. In some embodiments this will test if there is not any pending-task entry in a resource-associated data-structure associated with that lock. If implemented as an ACE request, the parallel status in the lock is that the lock-associated value X is determined as a result of the ACE(1,0) operation (e.g. if X=1 then it is changed to 0, indicating that the lock is free, and if X>1 then it is not changed in this time). Referring to the examples set forth in the previous drawings, stage 510 may include attempting to unlock a resource 100 by trying to release an associated lock 210.

If the attempt to unlock the resource is successful (denoted as YES in 520 of the drawing) then in stage 530 the process will receive a RELEASE-LOCK value (e.g. a SUCCESS value). The process then may move on to another task, wait, end, and so forth, but may no longer utilize the resource.

If the unlocking attempt (e.g. the ACE operation) of the lock fails (denoted as NO in 520 of the drawing) then in stage 540 the process will get a global lock (if the global lock is already taken, it will wait for it, and may also queue for it or otherwise register in a global data-structure associated with that global lock). For example, the releasing request of the previously-permitted process to release the locking of the resource may be denied in method 500 when the resource-associated data structure includes a non-zero number of pending-task entries.

According to an embodiment of the invention, for any process whose request to access a respective resource was denied, an attempt may be made to acquire a global lock for the respective process, and access may be granted to the respective resource for performing of the respective task only after the global lock was acquired for the respective process. That is, the method may include conditioning a granting of access to the respective resource for performing of the respective task so that access is granted only after the global lock has been acquired for the respective process.

Referring to the examples set forth in the previous drawings, stage 540 may include getting global lock 230. It is noted that the global lock is the only global lock associated with the resource (and with its associated lock whose unlocking was attempted at stage 510), and is possibly shared by a group of locks used for the locking of multiple resources.

Once the global lock is locked, in optional stage 560 the process will check if the resource may be unlocked. This may be carried out, for example, by checking a value of a contention status and/or the lock-associated value X, but may also be carried out as another request to the lock. For example, stage 560 may include determining whether the lock-associated value X indicates that there are not any pending-task entries in the resource-associated data-structure associated with the lock (if such a resource-associated data-structure is at all managed in this time—because in some embodiments It is not managed if it is emptied). This may be done, by way of example, by checking whether the lock-associated value equals zero (X=0?), in an implementation in which the lock associated value X was previously updated in previous stage 550.

The lock-associated value X would indicate that there are no pending-task entries in the resource-associated data-structure associated with the lock if there were no pending-task entries pending before the decreasing of the lock-associated value X (e.g. from 1 to 0). Furthermore, it is noted that even though before getting the global lock by the leaving process there were pending-task entries in the resource-associated data-structure and even if no other process was permitted to acquire the lock, there may still be situations in which the resource-associated data-structure will be empty of pending-task entries. For example, a process that added a pending-task entry into the resource-associated data-structure may remove it therefrom (e.g. due to elapsed timing), or such a pending-task entry may be removed therefrom by an entity other than the adding process (e.g. if detecting that the adding process ended unexpectedly).

If stage 560 is not implemented, then method 500 continues with stage 580 (as if the result of the not-performed stage 560 is negative).

Optional stage 550 (which may precede stage 560) includes updating (or instructing an update of) the lock-associated value X and/or the contention status. It is noted that in some embodiments of the invention, both lock-associated value X and contention status may be used. For example, one of these values may be used to indicate whether the resource is locked or not (and may be a binary value, for example), while the other may be used to indicate the number of pending-task entries in the lock-associated data-structure (possibly added with the locking process). For example, the updating of stage 550 may include decreasing the lock-associated value by one (X=X−1). It is noted that stage 550 may also be carried out after stage 560 or concurrently thereto, in other embodiments of the invention.

According to an embodiment of the invention, stage 550 is carried out in a single atomic operation. According to an embodiment of the invention, stage 550 and 560 are carried out together, in an atomic uninterruptable operation (wherein updating of the lock-associated value X may follow, if locking is denied).

If a result of stage 560 is that the resource may be unlocked (denoted as YES in 560) and possibly available to locking by other processes—because the lock-associated value X and/or the contention status were updated previously, then in stage 570 the process will receive a RELEASE-LOCK value (e.g. a SUCCESS value). The process then may move to another task, end, wait, and so forth. The positive result of stage 560 is also followed by stage 565 of releasing the global lock by the process. Stage 565 may precede stage 570 and may follow it.

If a result of stage 560 is that the resource may not be simply unlocked (denoted as NO in 560) by the leaving process (e.g. because there are pending tasks pending for it), then in stage 580 the leaving process will select (or instruct a selection) a pending-task entry from a resource-associated data-structure associated with the resource. The process will release the global lock in stage 585, after the selecting of the pending-task entry. Referring to the examples set forth in the previous drawings, stage 580 may include selecting the pending-task entry from a resource-associated data-structure such as resource-associated data-structure 220. According to an embodiment of the invention, the resource-associated data-structure may be a resource-associated queue, but this is not necessarily so. It is noted that the selection of the pending-task entry from the resource-associated data-structure may be followed by removing of that pending-task entry from the resource-associated data-structure.

Stage 580 may also include (or be followed by) removing of the selected pending-task entry from the resource-associated data-structure. As aforementioned, according to an embodiment of the invention, the resource-associated data-structure does not exist if there are currently no pending-task entries that await the lock. Therefore, according to an embodiment of the invention, on top of the removing of the pending-task entry from the resource-associated data-structure, method 500 may further include checking if a respective resource-associated data-structure is emptied by the removing, and if so, ending (or deactivating) the respective resource-associated data-structure. The ending may be carried out by the process, by the lock, by an entity associated with the lock, and/or by an entity associated with multiple locks (e.g. a locking manager).

According to an embodiment of the invention, after releasing the global lock the process may continue to other tasks, end, wait, and so forth (denoted stage 595). However, according to an embodiment of the invention, the process does not continue directly to stage 595, but rather previously carry out stage 590 in which it executes (or instructs execution of) content included in the selected pending-task entry, content pointed to in the pending-task entry, and/or execute according to such content.

For example, if the content of the selected pending-task entry is an indication of another process that added the pending-task entry to the resource-associated data-structure then the execution of stage 590 may include indicating that this other process should get the lock. In another example, if the content of the selected pending-task entry includes instructions and/or content of a task to be performed, then the execution of stage 590 may include carrying out that task before releasing the lock. In such a case, stage 590 may be followed by reiteration of method 500 from stage 510 onwards.

Referring to method 400 as well as to method 500, it should be noted that while the global lock may be used for locking and/or for unlocking of locks, it is not necessarily used in any instance of locking and/or of unlocking. In many instances (especially when the number of locks substantially exceeds the number of concurrently running processes, even by several magnitudes of order, e.g. 1,00, 1,000, or 10,000 as much), there are relatively few contentions occurring at the local locks (stages tiltable propulsion unit 420 and 520) and therefore few processes concurrently waiting for the global lock.

Furthermore, the operations that processes execute when holding the global lock (e.g. adding a pending-task entry to a queue, updating a contention-status) are relatively very simple, and in many implementations take far less time than the execution of tasks requested by the processes, and therefore the waiting for the global lock—even if inflicted on a process—usually does not result in substantial delay to that process. In at least some cases in which the number of locks substantially exceeds the number of concurrently running processes, the efficiency achieved in all the instances in which there is no contention at the locks entirely overshadows any harm inflicted on those few processes, which are somewhat delayed as described.

Returning to FIG. 1, it is noted that according to an embodiment of the invention, unlocking (or releasing) of locks may be implemented in accordance with method 500. According to an embodiment of the invention, when there are pending task-entries pending for a lock (e.g. in an associated queue), a process currently locking the resource does not simply unlock the resource, but rather has to acquire the global lock in order to successfully unlock (or release) the resource. This may be done either on an advisory basis in which cooperation of such a process or thread is required and expected, or on a mandatory basis in which improper unlocking or releasing of a lock by such a process or thread is prevented, e.g. by forcing a respective exception in attempting entity. As aforementioned, the resource-associated data-structure 220 is not necessarily maintained at all times, and may be generated only when required (e.g. when at least one pending-task entry is included therein).

According to an embodiment of the invention, the process which attempts to release the locking may attempt to do so simply (e.g. by initiating an uninterruptible atomic test-and-set operation, e.g. similarly to the action of stage 510 of method 500). If this attempt is successful (e.g. when there are no pending-task entries pending in the associated resource-associated data-structure) then the attempting process releases the locking and continues to operate or end, depending on its instructions.

If, however, the initial attempt to release the locking of the resource fails, the process may not unconditionally release the locking or even unconditionally select (or instruct a selection of) a pending-task entry 222 from the respective resource-associated data-structure 220 for which the resource will be locked. In different embodiments of the invention, this is ensured on an advisory basis in which cooperation of such a process or thread is required and expected, and may also be ensured on a mandatory basis in which unauthorized attempt to release the lock and/or to select a pending-task entry by such a process or thread is prevented, e.g. by forcing a respective exception in the attempting entity.

In order to release the locking according to such embodiments of the invention, the releasing process has to select (or instruct a selection of) a pending-task entry 222 from the respective resource-associated data-structure 220. Such a selection is usually carried out according to one or more selection rules. For example, if the resource-associated data-structure 220 is a queue, the selection of the pending-task entry may be implemented in response to a location of the pending-task entry in the queue 220 (e.g. selection of the topmost pending-task entry in the queue). In order for any such selection to be carried out, the releasing process first has to acquire global lock 230. According to an embodiment of the invention, the global lock 230 has to be acquired by any process whose attempt to release any of the locks 210 failed, in order for releasing thereof.

As aforementioned, while not necessarily so, global data-structure 240 may be implemented for storing pending-process entries 242 which are associated with processes that await to acquire the global lock 230. Such pending-process entries may be associated with processes whose attempt to release a lock failed, as well as with processes whose attempt to lock a resource failed. As aforementioned, the global data-structure 240 may be implemented, if at all implemented, as a queue, but this is not necessarily so, and other (ordered or unordered) data-structures may be implemented. As furthermore mentioned, the pending-process entries 242 may be implemented differently in different embodiments of the invention, and may include, for example, an identifier of the process, a pointer to the process and/or to a location accessible by which, a pointer to a function that should be carried out when the respective entry is selected (e.g. for calling the process), and so forth.

As also mentioned above, global data-structure 240 is not necessarily implemented, and other mechanisms may be implemented instead, e.g. recurrent attempting to acquire the global lock 230 by processes or threads awaiting it, e.g. after waiting a randomly (or pseudo-randomly, or priority-based, etc.) selected amount of time, which may differ from process to process.

According to such an embodiment of the invention, when a process whose attempt to release the locking was previously denied (e.g. by a lock 210) acquires the global lock, it may then select (or instruct a selection of) a pending-task entry from the associated resource-associated data-structure 220. However, according to some embodiments of the invention, such a previously denied process does not immediately select a pending-task entry 222 from the respective resource-associated data-structure 220, but priorly attempts to unlock the respective resource 100 once again (e.g. by an atomic operation as discussed above). If successful, such a process would release the global lock in response.

It is noted that from the time that the unlocking by the process was denied because there was a pending-task entry in the respective resource-associated data-structure 220 until the time in which that process acquired the global lock, the previously pending-task entry (or entries) pending may have been removed from the resource-associated data-structure 220 for one reason or other (e.g. because the process associated with such entry unexpectedly ended). In such cases, it may not be necessary to select a pending-task entry 222 from the resource-associated data-structure 220.

As aforementioned, according to some embodiments of the invention, a contention status may be associated with each of the resources 100 (or at least with the locked ones among them), which may indicate how many processes, or tasks, are waiting for the resource 100 (e.g. how many pending-task entries 222 are included in the associated resource-associated data-structure 220). According to other embodiments of the invention, the contention lock may not indicate an exact number of waiting processes, or tasks, but otherwise indicate a status of the lock 210 (e.g. locked/unlocked) or of its contention status (e.g. no pending tasks/one task is pending/more than one task is pending). In embodiments of the invention in which the contention status indicates the number of the waiting processes or tasks, this number may and may not include the process which currently locks the resource 100.

According to an embodiment of the invention, upon acquisition of the global lock 230 by the process attempting to release the locking on the resource, the contention status associated with the resource 100 may be updated (e.g. by that process—such as due to exclusive contention status access granted to it, or by other entity, such as a locks manager—not illustrated). The updating may be a decreasing of a number that is stored in the contention status (and/or indicated by it) by one. The updating of the contention status may be carried out before or after the second attempt to release the locking, if implemented.

Once the process that acquired the global lock selected (or instructed the selection of) the pending-task entry (and possibly instructed a removal of that pending-task entry from the resource-associated data-structure, after it or another process acquired the content of that pending-task entry), the releasing process would release the global lock. The global lock 230 may then be acquired by another process (which either waits for the global lock 230, or attempts to acquire it at a later time—e.g. for locking the resource 100).

According to an embodiment of the invention, after releasing the global lock the releasing process may continue to other tasks, end, wait, and so forth. However, according to an embodiment of the invention, this process does not continue immediately, but rather previously it executes (or instructs execution of) content included in the selected pending-task entry, content pointed to in the pending-task entry, and/or execute according to such content.

For example, if the content of the selected pending-task entry is an indication of another process that added the pending-task entry to the resource-associated data-structure then the execution by the releasing process may include indicating that this other process should get the lock. In another example, if the content of the selected pending-task entry includes instructions and/or content of a task to be performed, then the execution by the releasing process may include carrying out that task before releasing the lock. In such a case, such execution may be followed by reiteration of an attempt to release the locking on the resource.

When concluding processes or thread does not necessarily release the locking, but rather, according to some embodiments of the invention, execute a task indicated in the selected pending-task entry 222, some or all of the processes that add pending-task entries 222 to one or more resource-associated data-structures 220 are not required to wait until the respective resource 100 is free, and may continue with other tasks, counting on another process (not necessarily a previously identified one) to pick up the task and conclude it.

It should be noted that method 500 may be reiterated for several process and possibly also for several locks. The corresponding stages in any such two or more reiterations are not necessarily carried out in an orderly fashion. For example—if a first process got the global lock in stage 540 of a first iteration, before a second process has done so in a second iteration, the second process may nevertheless release the locking on the resource (at stage 570) in some situations before the first process will do so. This may occur for example if the processes attempt to release different locks—even though these two processes still have to get the same global lock in stage 540.

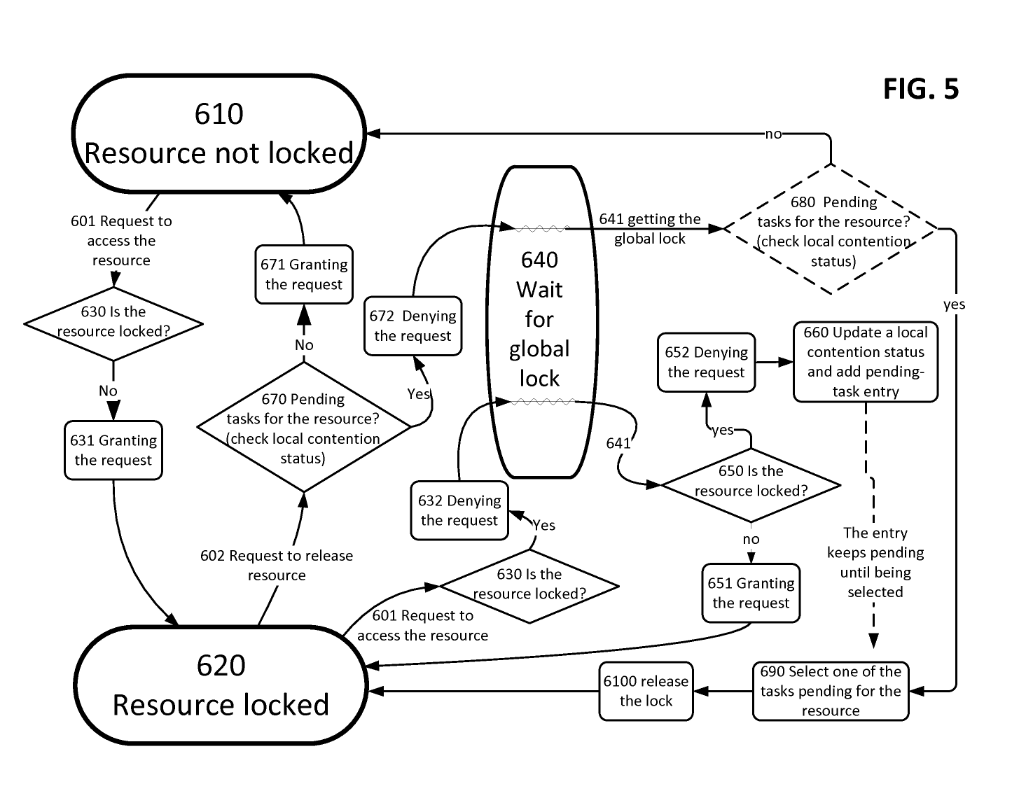

FIG. 5 illustrates different states of some components of system 200 during its operation, according to an embodiment of the invention. The different states illustrated pertain to a single resource 100 and to its single associated lock 210. The locking state of each of the different resources 100 does not depend on the locking state of any of the other resources 100 or its associated components (e.g. locks 210 associated with such other resources 100), except the state of the global lock 230 in the sense that modification in the locking state of each of the resources 100 may require acquiring of the global lock 230 by a process, before the locking state of that resource 100 may be changed. However, as will be demonstrated below, in some situations the locking-state of a resource 100, and changes in this state, does not depend even on the state of the global lock 230.

Two locking states are considered for each of the resources 100. State 610 in which the resource 100 is not locked, and state 620 in which it is locked. It should be noted that in some embodiments of the invention, the definition of the locking states may differ somewhat. For example, state 610 may be differently defined as a state in which the contention status indicates that there are no pending-task entries 222 pending in the respective resource-associated data-structure 220 (if that such a data-structure 220 is not maintained because it was emptied), and/or a state in which the respective lock-associated value X equals zero. Continuing the same example, state 620 may be differently defined as a state in which the contention status indicates that there are pending-task entries 222 pending in the respective resource-associated data-structure 220, and/or a state in which the respective lock-associated value X is greater than zero.

There are two operations that may ultimately result in changing of a locking state of the respective resource 100. One of these operations is requested (or attempted) by a process to access the resource (to lock it). This operation is denoted 601. The second operation is attempting to release a locking on the resource 100. This operation is denoted 602.

Operation 601 of attempting to access the resource 100 (which requires its locking for the requesting process) prompts an examination of whether the resource is locked or not (denoted 630). When attempting to lock the resource by the requesting process (601) when the resource is not locked (610), operation 630 results in granting of the request (denoted 631). The granting may entail sending a SUCCESS value to the process. When attempting to lock the resource by the requesting process (601) when the resource is locked (620), operation 630 results in denying of the request (denoted 632). The denying may entail sending a FAILED value to the process. Operation 630 may be execution of stage 320 of method 300, but this is not necessarily so.

Prompted by the request 601 that is being granted at 631, the resource 100 is then locked for the requesting process, and the locking state of the resource 100 is switched to state 620. If, however, the request is denied (at 632), the locking state of the resource is kept unchanged.

If the lock 210 is an atomic lock, the combination of operations 630 and 631 (which is executed when the request 601 is made when the resource 100 is not locked) may be carried out as an uninterruptable atomic operation. Likewise, if the lock 210 is an atomic lock, the combination of operations 630 and 632 (which is executed when the request 601 is made when the resource 100 is locked) may be carried out as an uninterruptable atomic operation.

In cases where the request is denied (at 632), the process then waits until it gets the global lock 230 (denoted 640). The waiting may be preceded by adding a pending-process entry 242 into a possibly implemented global data-structure 240 associated with the global lock, wherein each pending-process entry 242 pending in the global data-structure 240 is associated with a process that awaits to acquire the global lock 230. Alternatively, other mechanisms may be implemented for acquiring the global lock 230, such as those exemplified above.

In order to leave the waiting state (640), the process has to get the global lock 230 (denoted 641). It may get the lock by having the pending-process entry 242 associated with it selected (e.g. by a process attempting to releasing the locking of resource 100, or by a locking manager), or otherwise (e.g. by reiteratively requesting for it). It is noted that in some embodiments of the invention the process may leave this waiting state (640) also at its own discretion (not illustrated, e.g. due to timing-out), but in such a case it cannot pursue actions that require holding of the global lock 230.

Once the requesting process previously denied in 632 gets the global lock (in 641), it possibly attempts again to get the lock 210 to lock the resource 100, which in turn prompts an examination of whether the resource 100 is locked or not (denoted 650). 650 may be implemented like 630, but this is not necessarily so. It should be noted that in embodiments of the invention in which this process does not attempt to get the lock, the getting of the global lock leads to 660.

If the examination 650 results in a negative result—indicating that the resource 100 is not locked (610)—the locking attempt results in granting of the request (denoted 651). The granting may entail sending a SUCCESS value to the process. If the examination 650 results in a positive result—indicating that the resource 100 is locked (620)—the locking attempt results in denying of the request (denoted 652). The denying may entail sending a FAILED value to the process.

Prompted by the attempt which follows that getting of the global lock and that is being granted at 651, the resource 100 is then locked for the requesting process, and the locking state of the resource 100 is switched to state 620. If, however, the request is denied (at 652), the locking state of the resource is kept unchanged, and the process then executes 660 that includes updating (or instructing an update of) a local contention status associated with the resource 100 (and/or the lock-associated value X) and adding (or instructing an adding of) a pending-task entry 222 into a resource-associated data-structure 220 associated with the resource 100.

Following the execution of 660, the pending-task entry 222 keeps pending in the resource-associated data-structure 220 until being selected (or removed therefrom due to timing-out, etc.). As aforementioned, the requesting process may wait for the selection of the pending-task entry 222 added, but may also continue otherwise (e.g. switch to another task, wait, end).

Returning to the second operation 602 of attempting to release a locking on the resource 100, it is noted that the attempting to release the resource is carried out by a process currently locking the resource 100, and therefore may initiate from the second locking state 620.

Operation 602 of attempting to release the locking on the resource 100 prompts an examination of whether the resource 100 may be unlocked or not (denoted 670). The examination of whether the resource 100 may be unlocked may entail checking whether there are pending-task entries 222 in the resource-associated data-structure 220, and/or checking the contention status of the resource 100 (and/or the respective lock-associated value X). Operation 670 may be an execution of stage 420 of method 400, but this is not necessarily so.

When attempting to unlock the resource 100 by the requesting process (602) when there are no pending-task entries 222 in the resource-associated data-structure 220 (if it at all, managed at that time), operation 670 results in granting of the request (denoted 671). The granting may entail sending a SUCCESS value to the process. The granting 671 may be followed by unlocking the resource 100 by that process, which results in changing of the locking status of the resource 100 to unlocked (610).

When attempting to unlock the resource by the requesting process (602) when there are pending-task entries 222 pending in the resource-associated data-structure 220, operation 670 results in denying of the request (denoted 672). The denying may entail sending a FAILED value to the process.

If the lock 210 is an atomic lock, the combination of operations 670 and 671 (which is executed when the request 602 is made when the resource 100 may be unlocked) may be carried out as an uninterruptable atomic operation. Likewise, if the lock 210 is an atomic lock, the combination of operations 670 and 672 (which is executed when the request 602 is made when the resource 100 may not be unlocked) may be carried out as an uninterruptable atomic operation.

In cases where the request was denied (at 672), the process then waits until it gets the global lock 230 (denoted 640). The waiting may be preceded by adding a pending-process entry 242 into a possibly implemented global data-structure 240 associated with the global lock, wherein each pending-process entry 242 pending in the global data-structure 240 is associated with a process that awaits to acquire the global lock 230. Alternatively, other mechanisms may be implemented for acquiring the global lock 230, such as those exemplified above.

In order to leave the waiting state (640), the process has to get the global lock 230 (denoted 641). It may get the lock by having the pending-process entry 242 associated with it selected (e.g. by a process attempting to releasing the locking of resource 100, or by a locking manager), or otherwise (e.g. by reiteratively requesting for it). It is noted that in some embodiments of the invention the process may leave this waiting state (640) also at its own discretion (not illustrated, e.g. due to timing-out), but in such a case it cannot pursue actions that require holding of the global lock 230.

The similar notation (641) used for the getting of the local lock by processes which attempt to lock the resource 100 as well as by processes which attempt to unlock the resource 100 is used to indicate that in some implementations, the selecting of pending-task entries 222 from the resource-associated data-structure 220 is carried out irrespectively to the type of the attempt by the process. For example, if the resource-associated data-structure 220 is managed as a single queue, then a pending-task entry 222 will be selected according to its position (e.g. topmost position) in the queue 220, regardless of whether it is an entry 222 associated with a process attempting to lock the resource 100 or with a process attempting to unlock it.

However, it is noted that in other implementations, the one or more selection rules used for selecting of a pending-task entry 222 out of the entries 222 of resource-associated data-structure 220 (in 690) may be responsive to the type of the attempting process (attempting to lock or to unlock).

Once the requesting process previously denied in 672 gets the global lock (in 641), it possibly attempts again to unlock the resource 100, which in turn may prompt an examination of whether the resource 100 may be unlocked or not (denoted 680). The examination of whether the resource 100 may be unlocked may entail checking whether there are pending-task entries 222 in the resource-associated data-structure 220, and/or checking the contention status of the resource 100 (and/or the respective lock-associated value X). 680 may be implemented like 670, but this is not necessarily so. It is noted that in embodiments of the invention in which this process does not attempt again to unlock the resource 100, the getting of the global lock leads to 690.

In 690, a pending-task entry 222 is selected from the resource-associated data-structure 220 associated with the resource 100. The selecting may be executed (or instructed) by the process attempting to unlock the resource 100, but this is not necessarily so, and it may also be carried out by another entity (e.g. a locking manager). It is noted that the selection of the pending-task entry 222 from the resource-associated data-structure 220 may be followed by removing of that pending-task entry 222 from the resource-associated data-structure 220.

In 6100 the process will release the global lock 230, after the selecting of the pending-task entry 222. According to an embodiment of the invention, after releasing the global lock 230 the process may continue to other tasks, end, wait, and so forth (denoted stage 595). However, according to an embodiment of the invention, the process does not continue directly to 6100, but rather previously executes (or instructs execution of) content included in the selected pending-task entry 222, content pointed to in the pending-task entry 222, and/or execute according to such content.

For example, if the content of the selected pending-task entry 222 is an indication of another process that added the pending-task entry 222 to the resource-associated data-structure 220 then the execution may include indicating that this other process should get the lock 210. In another example, if the content of the selected pending-task entry 222 includes instructions and/or content of a task to be performed, then the execution may include carrying out that task before releasing the lock 210. In such a case, such execution may be followed by reiteration of 602.

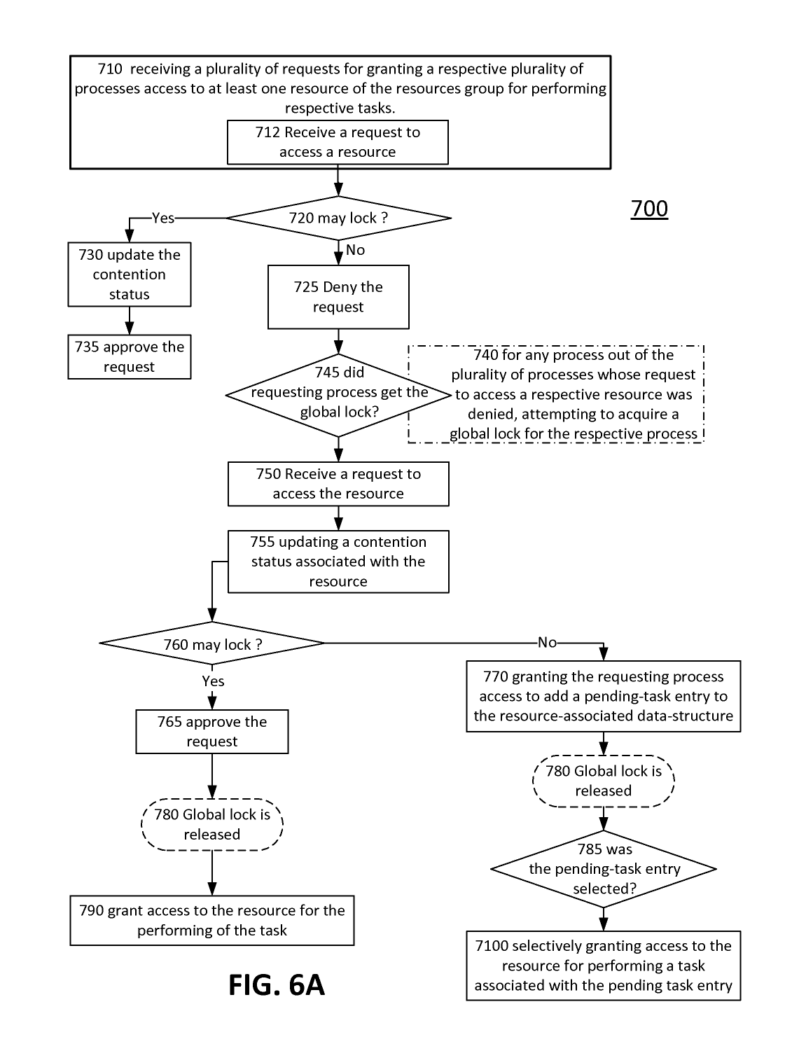

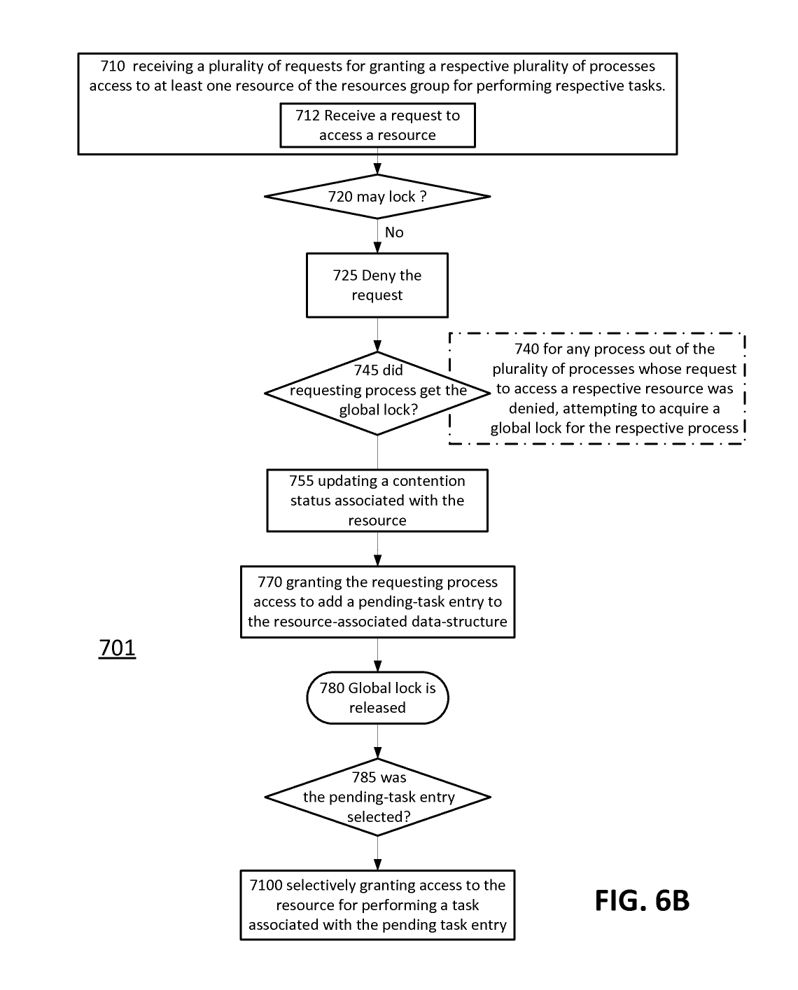

FIG. 6A is a flow chart of method 700 for controlling access to a resources group that includes multiple computer accessible resources, according to an embodiment of the invention. Referring to the examples set forth in the previous drawings, according to an embodiment of the invention, method 700 may be carried out by any processor of 290 of system 200 or by a combination thereof, and may also be carried out by a combination of one or more processors 290 and locks 210. According to an embodiment of the invention, method 700 may be implemented by a dedicated module or modules—whether a software module, a hardware module, and/or a firmware module.

The requesting process pertained to in method 700 may be any process running in system 200 (e.g. a process run by processor 290, and/or by an external processor 290′, if implemented). The flowchart of FIG. 6A may be used to describe a way system 200 reacts to a TRY-LOCK action performed by some process against a lock 210 trying to gain access to a resource 100 lockable by that lock 210, according to an embodiment of the invention. According to an embodiment of the invention, when any process needs exclusive access to the resource, it tries to lock the associated lock.

Method 700 is related to method 400, and these two methods may be carried out in parallel. All the more so, according to an embodiment of the invention, according to an embodiment of the invention these two methods may be implemented by the same processor, e.g. wherein different modules run by that processor may carry out the respective stages of these two methods. For example, a process run by the processor may issue a request to attempt a resource, and this request may be received and managed by a lock implemented on the same processor (whether by hardware or by software).

Each of the locks referred to in method 700 (and in the other methods)—other than the global lock—is a resource-associated lock of a respective resource. Referring to the examples set forth in the previous drawings, such a resource-associated lock may be for example a lock 100.

Stage 710 includes receiving a plurality of requests for granting a respective plurality of processes access to at least one resource of the resources group for performing respective tasks. Different requests of the plurality of requests that pertain to a single resource of the resources group may or may not compete with each other, e.g. depending on the timing of such requests. However, some of such requests may result indeed compete for access to the same resource. The receiving of stage 710 may be carried out by one or more resources and/or by one or more resource-associated locks associated therewith.

The receiving of each of the requests in stage 710 may include receiving such requests to lock the respective one or more resources implemented as requests for atomic compare-and-exchange operations (ACE, potentially implementable as a “compare-and-swap” or a “compare-and-set” operation), e.g. as exemplified in relation to method 300, and especially to stage 310. Such requests may include, for example, a compare value (denoted C) and may also include an exchange value (denoted E). The compare value C is the value that if equal to a lock-associated value (denoted X) associated with a respective lock (e.g. the lock-associated value may be the aforementioned contention-status), the requesting process will get the lock. The exchange value E is the value to which the lock-associated value X is updated. In other embodiments, the exchange value E may be omitted. According to an embodiment of the invention, both the compare value C and the exchange value E (if implemented) may pertain to the lock-associated value X (and/or to the contention status) which indicates the amount of pending-task entries pending in a resource-associated data-structure associated with the resource.

Stage 712 includes receiving a request by a process (also referred to in the context of method 700 as “the requesting process”) to access a resource (this may be an express request to lock the resource, but not necessarily so). The request received in stage 712 is one of the plurality of requests received in stage 710.

Stage 720 includes attempting to lock the resource, which may be implemented by running an atomic compare-and-exchange operation (ACE, potentially implementable as a “compare-and-swap” or a “compare-and-set” operation) by the lock, e.g. with values C=0 and E=1. In some embodiments this will test if the lock is free and its associated resource-associated data-structure is empty. If implemented as an ACE request, the parallel status in the lock is that the lock-associated value X is determined as a result of the ACE(0,1) operation (e.g. as discussed in relation to method 300).

That is, according to an embodiment of the invention, method 700 may include in stage 712 receiving a request to lock the resource and in stage 720 attempting to lock the resource by running an atomic compare-and-exchange operation by the lock which includes comparing a compare value included in the request to a lock-associated value that is indicative of the number of pending-task entries in the resource-associated data structure, wherein the result of the attempting depends on a result of the comparing.

If the attempt to lock the resource is successful (denoted as YES in 720 of the drawing) then stage 735 is carried out, which includes sending an approval indication to the requesting process (E.g. a GOT-LOCK value, the SUCCESS value of method 300). The process then may utilize the resource (e.g. by reading from it, writing to it, using it for communication, and so forth).

Stage 730 may also be carried out if the attempt to lock the resource is successful, which includes updating the contention status and/or the lock-associated value X. According to an embodiment of the invention, the updating may be carried out in the same atomic operation as the attempting (and especially the comparing, if implemented) of stage 720. According to an embodiment of the invention, the sending of stage 735 may also be carried out in the same atomic operation.

If the locking attempt (e.g. the ACE operation) on the lock fails (denoted as NO in 720 of the drawing) then stage 725 is carried out, that includes denying the request of the process to access the resource. This may occur when the resource is locked. Even if no process is utilizing the resource at the time of the attempt, the attempt may still fail—e.g. if there are pending-task entries pending in the resource-associated data-structure.

Stage 725 includes denying the request (which is, as aforementioned, one of the plurality of requests) of the requesting process to access the respective resource when a resource-associated lock of that respective resource is locked.

After the request of stage 712 is denied, the requesting process is expected to acquire a global lock in order for the method to proceed. If the process does not acquire the global lock (e.g. due to timing-out or unexpected termination of the process), method 700 cannot continue. This is illustrated by stage 745 which conditions continuation of the carrying out of method 700 with the getting of the global lock by the requesting process. According to an embodiment of the invention, the global lock has to be acquired by any process whose request to access any resource of the resources group for performing of any task was denied, in order for access thereto for performing the respective task to be granted.

Method 700 may include stage 740 that includes attempting, for any process out of the plurality of processes whose request to access a respective resource was denied, to acquire a global lock for the respective process, wherein the granting of access to the respective resource for performing of the respective task is conditioned so that the access is granted if and only if the global lock has been acquired for the respective process, and only after the global lock has been acquired for the respective process.

Method 700 may also include granting access to the respective resource for performing the respective task only after the global lock was acquired for the respective process. Method 700 may include conditioning granting of access to the respective resource for performing of the respective task so that the access is granted only after the global lock was acquired for the respective process.

Referring to the examples set forth in the previous drawings, the global lock may be a global lock such as global lock 230 of system 200, and/or the global lock of method 400. In the latter case, the condition of stage 745 is met when the requesting gets the global lock as described in relation to stage 440. It is noted that the global lock is the only global lock associated with the resource (and with its associated lock whose locking was attempted at stage 712), and is possibly shared by a group of locks used for the locking of multiple resources.

According to an embodiment of the invention, method 700 may include adding to a global data-structure a pending-process entry associated with the process, wherein the global data-structure includes pending-process entries of any process whose request to access any resource of the resources group for performing any task, was denied. It will be clear to a person who is of skill in the art that the pending-process entries of the different processes whose requests to access various resources of the resources group were denied, may be included in the global data-structure at different times.

Method 700 may include granting, upon acquisition of a global lock for a process that is associated with the request, exclusive access to a resource-associated data structure and adding to the data structure a pending-task entry that is associated with the process.

For example, the adding may include enqueuing in a global queue a pending-process entry associated with the process, wherein the global queue queues pending-process entries of any process whose request to access any resource of the resources group for performing any task, was denied.

Once the global lock is locked, optional stage 750 may be carried out, which includes receiving another request to access the resource (checking if the resource is available for locking). Stage 760 includes attempting to lock the resource, which may be implemented by running an atomic compare-and-exchange operation (ACE, potentially implementable as a “compare-and-swap” or a “compare-and-set” operation) by the lock, e.g. with values C=0 and E=1. In some embodiments this will test if the lock is free and its associated resource-associated data-structure is empty. If implemented as an ACE request, the parallel status in the lock is that the lock-associated value X is determined as a result of the ACE(0,1) operation (e.g. as discussed in relation to method 300).

According to an embodiment of the invention, the granting of the access to add the pending-task entry into the resource-associated data structure in stage 770 is preceded by attempting to lock the resource for the process (in stage 760), and is selectively carried out only if the attempt failed.

According to an embodiment of the invention, method 700 may include in stage 750 receiving a request to lock the resource and in stage 760 attempting to lock the resource by running an atomic compare-and-exchange operation by the lock which includes comparing a compare value included in the request to a lock-associated value that is indicative of the number of pending-task entries in the resource-associated data structure, wherein the result of the attempting depends on a result of the comparing.

It is noted that, according to an embodiment of the invention, the checking if the resource may be locked is not carried out by the lock in response to a request by the process, but rather by a checking made by the process of a value of a contention status and/or the lock-associated value X. Stage 760 may include determining whether the lock-associated value X indicates that the lock is currently not locked.

Stage 760 may be preceded by optional stage 755 of updating the lock-associated value X and/or the contention status. The updating of stage 755 may be implemented by the requesting process, or by another entity—such as by the lock or by a locks manager—e.g. in response to an instruction from the process. It is noted that in some embodiments of the invention, both lock-associated value X and the contention status may be used. For example, one of these values may be used to indicate whether the resource is locked or not (and may be a binary value, for example), while the other may be used to indicate the number of pending-task entries in the lock-associated data-structure (possibly added with the locking process). For example, the updating of stage 755 may include increasing the lock-associated value by one (X=X+1) and/or modifying the contention status associated with the resource from available (or “unlocked”) to unavailable (or “locked”). It is noted that stage 750 may also be carried out after stage 760 or concurrently to which, in other embodiments of the invention.

According to an embodiment of the invention, stage 760 and stage 755 of updating of the lock-associated value and/or of the contention status are carried out together, in an atomic uninterruptable operation (wherein updating of the lock-associated value X may follow, if locking is denied).

If the attempt to lock the resource in stage 760 is successful (denoted as YES in 760 of the drawing) then stage 765 is carried out, which includes sending an approval indication to the requesting process (E.g. a GOT-LOCK value, the SUCCESS value of method 300). The process then may utilize the resource (e.g. by reading from it, writing to it, using it for communication, and so forth)—but is first expected to release the global lock (denoted 780).

According to an embodiment of the invention, if the attempt to lock the resource is successful, the method also includes updating the lock-associated value X. According to an embodiment of the invention, the updating may be carried out in the same atomic operation as the attempting (and especially the comparing, if implemented) of stage 760. According to an embodiment of the invention, the sending of stage 765 may also be carried out in the same atomic operation.

The sending of the approval in stage 765 may be followed by stage 790 of granting access to the resource for the performing of the task for which the process requested access to the resource. The access in such a case would be granted to the requesting process (even though in other embodiments, e.g. as exemplified below, it may also be granted to other processes). The granting of stage 790 may include granting to the resource an exclusive access (which means that the resource is locked and may not be accessed by any other process).

When the requesting process receives the approval of 765, it releases the global lock. The releasing of the global lock by the process may precede stage 765 and may follow it. The releasing of the global lock would however occur before the utilization of the resource by the resource, because the global lock is required only until the getting of the lock that locks the resource (or, as will be demonstrated below, for adding an entry to a resource-associated data-structure).

If a result of stage 760 is that the resource is unavailable for locking (denoted as NO in 760) by the requesting process (e.g. because it is currently locked by another process and/or because another one or more processes is waiting for the resource), then stage 770 is carried out, that includes granting the process exclusive access to add a pending-task entry into a resource-associated data structure associated with the resource. The process then may add (or instruct an adding) a pending-task entry to the resource-associated data-structure associated with the resource.

Following the adding of the pending-task entry, the process will release the global lock (denoted 780). Referring to the examples set forth in the previous drawings, stage 770 may include granting to the process exclusive access to add the pending-task entry to a resource-associated data-structure such as resource-associated data-structure 220. According to an embodiment of the invention, the resource-associated data-structure may be a resource-associated queue, but this is not necessarily so.

According to an embodiment of the invention, the resource-associated data structure is a resource-associated queue that is associated with the resource, and the selective granting following stage 785 is responsive to a position of the pending-task entry in the resource-associated queue. Especially, the selecting pertained to in stage 785 may be responsive to the position of the pending-task entry in the resource-associated queue. For example, the selecting may be selection of the first or topmost pending-task entry pending in the queue. Generally, the selecting pertained to in stage 785 may be carried out according to one or more local data structure selection rules.

After the requesting process added (or instructed the adding of) the pending-task entry to the resource-associated data-structure, it may then release the global lock (denoted 780).

The method continues with the selecting of that pending-task entry from the resource-associated data-structure. Until that pending-task entry is not selected, the respective task may not be performed. This is illustrated by stage 785 which conditions continuation of the carrying out of method 700 with the selection of the pending-task entry out of the resource-associated data-structure (that may and may not include more than one pending-task entry at that time). The selecting may be carried out by the lock, but this is not necessarily so and it may also be carried out by another entity such as a process that attempts to unlock the resource (see, for example, stage 580 of method 500) or by a locking manager.

It is noted that once the pending-task entry is added to the resource-associated data-structure following stage 770 (see also stage 480 of method 400), the process may wait for an indication that it may get the lock (e.g. due to some selection rule applied for selecting pending-task entries from the resource-associated data-structure) as shown in stage 7100, and may possibly also return a WAIT value. Once receiving an indication that it may get the lock (at stage 790), the process may cease waiting and get the lock, thereafter utilizing the resource (e.g. for performing its original task).

Stage 7100 includes selectively granting access to the resource for performing a task associated with the pending task entry. The granting of stage 7100 may include granting exclusive access to the resource (which means that the resource is locked and may not be accessed by any other process). According to an embodiment of the invention, the selective granting of the exclusive access to the resource for performing a task in stage 7100 is carried out after a releasing of the global lock by the process (in stage 780). This may be a mandatory or compulsory condition, but this is not necessarily so.

According to an embodiment of the invention, the selective granting of stage 7100 is carried out upon releasing of the resource associated lock associated with the resource—as the selection indicated in stage 785 may be carried out upon the releasing of the resource associated lock (also referred to as the locking release of the resource). It is noted that the selective granting is not necessarily concurrent with the selecting and/or the releasing of the lock, and may be carried out in some time difference (which may and may not exceed a few clock cycles of the processor).

It is however noted that the access (and a respective locking of the resource) is not necessarily granted to the requesting process. According to an embodiment of the invention, the process does not have to wait until the respective pending-task entry is selected from the resource-associated data-structure. In some embodiments of the invention, the process may turn to other tasks (or, alternatively, wait until other tasks are due or even end). According to an embodiment of the invention, when the respective pending-task entry is selected, another process (e.g. the process that just finished with the resource) carries out the task indicated in the pending-task entry or in another location pointed to in the pending-task entry.

It is noted that the granting of the access to the resource and/or the selecting of the pending-task entry from the resource-associated data-structure may be combined with removing of that selected pending-task entry from the resource-associated data-structure, and possibly also by updating of the contention status and/or of the lock associated value X. Any of these actions may be carried out by the process, by the lock, or by another entity such as a locking manager.

In an example, at stage 760 it is determined if the lock-associated value X is equal to 1. If it is (YES in stage 760), then X was equal to 0 prior to the increase of stage 750 (which in such an implementation means that no other process waits or holds the lock) and therefore it will release the global lock corresponding to stage 780 and a GOT-LOCK will be sent to it in stage 790. Continuing the same example, if the value of the lock-associated value X is greater than 1 (NO in stage 760), then X was greater than 0 prior to the increase of stage 750 (which in such an implementation means that at least one process waits or holds the lock) and therefore following stage 770 the process will enter a pending-task entry to the resource-associated data-structure (which may be, for example, the lock's waiting queue), release the global lock corresponding to stage 780 and will wait until selection of the pending-task entry in stage 785.

In different embodiments of the invention, the pending-task entries added to the resource-associated data-structure may be implemented in different ways—pertaining both to system 200 and to method 700 and to the methods discussed below. In some embodiments of the invention, the pending-task entries (e.g. pending-task entries 222) may include, for example, an identifier of the process adding them to the resource-associated data-structure, a pointer to the process and/or to a location accessible by which, a pointer to a function that should be carried out when the respective entry is selected (e.g. for calling the process), and so forth.

Such a function may be implemented in various ways, and even in different ways by different processes in a single implementation. For example, the selection of the pending-task entry from the resource-associated data-structure may be followed by carrying out of the function pointed to in the pending-task entry and which may be stored, for example, in a dedicated database, look-up-table, etc. The function, upon its execution, may perform various tasks such as any one or more of the following: indicating to the process that the pending-task entry was selected (e.g. allowing it to perform the task or delegate it to another thread or process), and/or indicating to another process (e.g. the process currently finished utilizing the resource) which task it should perform (content of such a task—e.g. material to be written to a mass-storage device—may be stored in another database and may include further instructions).

FIG. 6B is a flow chart of method 701, according to an embodiment of the invention. The stages of method 701 are substantially similar to those of method 700, but the optional second attempt to lock the resource at stages 750 and 760 is not illustrated.

Referring both to method 700 and to method 701, it should be noted that any of these methods may be reiterated for several processes and possibly also for several locks. The corresponding stages in any such two or more reiterations are not necessarily carried out in an orderly fashion. For example—if a first process is denied access in stage 725 of a first iteration, before a second process was denied access in a second iteration, the second process may nevertheless be granted access to the resource (at stage 7100) in some situations before the first process will get it. This may be so even if such processes added their pending-task entries to the same resource-associated data-structure (i.e. they both requested access to the same lock).

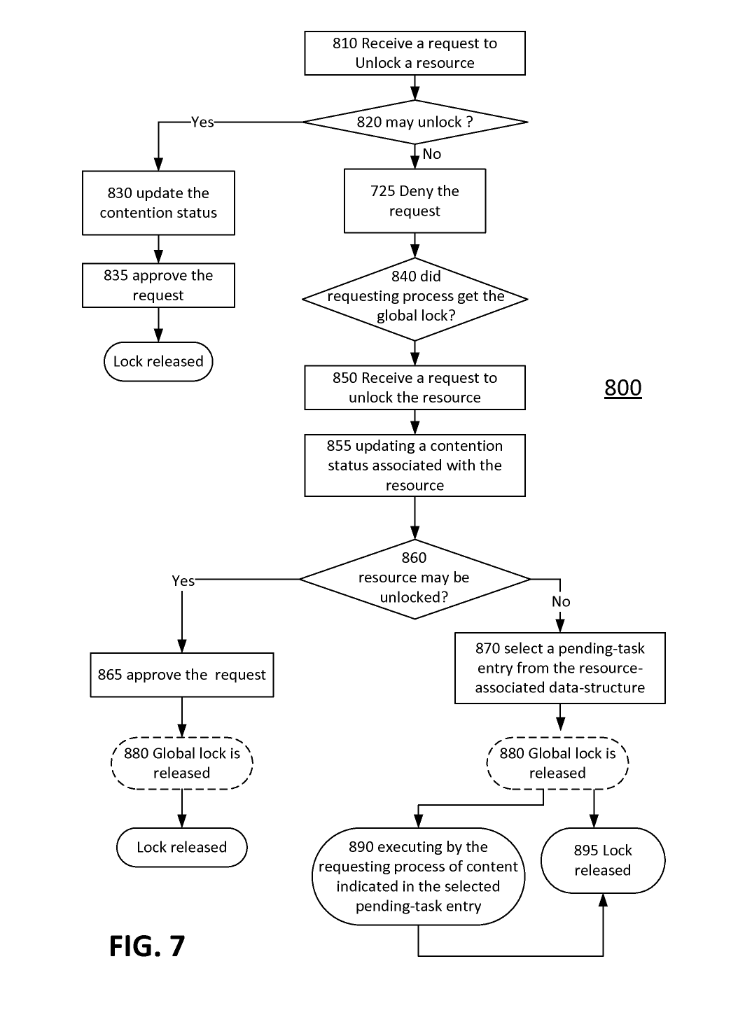

FIG. 7 is a flow chart of method 800 for controlling a releasing of a locking on a resource that is a member of a resources group that includes multiple computer accessible resources, according to an embodiment of the invention. Referring to the examples set forth in the previous drawings, according to an embodiment of the invention, method 800 may be carried out by any processor of 290 of system 200 or by a combination thereof, and may also be carried out by a combination of one or more processors 290 and locks 210. According to an embodiment of the invention, method 800 may be implemented by a dedicated module or modules—whether a software module, a hardware module, and/or a firmware module.

The process requesting to release the resource pertained to in method 800 may be any process running in system 200 (e.g. a process run by processor 290, and/or by an external processor 290′, if implemented). The flowchart of FIG. 7 may be used to describe a way system 200 reacts to a TRY-UNLOCK action performed by some process against a lock 210 trying to gain access to a resource 100 lockable by that lock 210, according to an embodiment of the invention. According to an embodiment of the invention, when any process needs exclusive access to the resource, it tries to lock the associated lock.

Method 800 is related to method 500, and these two methods may be carried out in parallel. All the more so, according to an embodiment of the invention, these two methods may be implemented by the same processor, e.g. wherein different modules run by that processor may carry out the respective stages of these two methods. For example, a process run by the processor may issue a request to attempt a resource, and this request may be received and managed by a lock implemented on the same processor (whether by hardware or by software).

According to an embodiment of the invention, method 800 may also be carried out in parallel with method 700. All the more so, according to an embodiment of the invention these two methods may be implemented by the same processor, e.g. wherein different modules run by that processor may carry out the respective stages of these two methods. For example, a process run by the processor may issue a request to attempt a resource, and this request may be received and managed by a lock implemented on the same processor (whether by hardware or by software). A way in which these two methods may be carried out in parallel is exemplified in FIG. 5, in which locking and releasing of locking of a single lock is exemplified.

Stage 810 includes receiving a request by a process (also referred to in the context of method 800 as “the requesting process”) to release a locking on a resource (to unlock the resource). This may be an express request to unlock the resource, but not necessarily so. The receiving may include receiving the request to lock the resource implemented as a request for an atomic compare-and-exchange operation (ACE, potentially implementable as a “compare-and-swap” or a “compare-and-set” operation). The request may include, for example, a compare value (denoted C) and may also include an exchange value (denoted E). The compare value C is the value that if equal to a lock-associated value (denoted X) associated with lock (e.g. the lock-associated value may be the aforementioned contention-status), the requesting process will be permitted to release its locking on the resource. The exchange value E is the value to which the lock-associated value X is updated. In other embodiments, the exchange value E may be omitted. According to an embodiment of the invention, both the compare value C and the exchange value E (in implemented) may pertain to the lock-associated value X (and/or to the contention status) which indicates the amount of pending-task entries pending in a resource-associated data-structure associated with the resource.

Stage 820 includes attempting to unlock the resource, which may be implemented by running an atomic compare-and-exchange operation (ACE, potentially implementable as a “compare-and-swap” or a “compare-and-set” operation) by the lock, e.g. with values C=1 and E=0. In some embodiments this will test whether there are no pending-task entries pending in a resource-associated data-structure associated with the resource. If implemented as an ACE request, the parallel status in the lock is that the lock-associated value X is determined as a result of the ACE(1,0) operation.

That is, according to an embodiment of the invention, method 800 may include in stage 810 receiving a request to unlock the resource and in stage 820 attempting to unlock the resource by running an atomic compare-and-exchange operation by the lock which includes comparing a compare value included in the request to a lock-associated value that is indicative of the number of pending-task entries in the resource-associated data structure, wherein the result of the attempting depends on a result of the comparing.

If the attempt to unlock the resource is successful (denoted as YES in 820 of the drawing) then stage 835 is carried out, which includes sending an approval indication to the requesting process (E.g. a SUCCESS value). The process may then continue in different ways (e.g. it may turn to another task, wait, end, etc.).

Stage 830 may also be carried out if the attempt to unlock the resource is successful, which includes updating the contention status and/or the lock-associated value X. According to an embodiment of the invention, the updating may be carried out in the same atomic operation as the attempting (and especially the comparing, if implemented) of stage 820. According to an embodiment of the invention, the sending of stage 835 may also be carried out in the same atomic operation.

If the unlocking attempt (e.g. the ACE operation) on the lock fails (denoted as NO in 820 of the drawing) then stage 825 is carried out, that includes denying the request of the process to unlock the resource. This may occur when there are pending-entry tasks pending in the resource-associated data-structure, but even before that (stage 750 of method 700 may be carried out before stage 780).

After the request of stage 810 is denied, the requesting process is expected to acquire a global lock in order for the method to proceed. If the process does not acquire the global lock (e.g. due to timing-out or unexpected termination of the process), method 800 cannot continue. This is illustrated by stage 840 which conditions continuation of the carrying out of method 800 with the getting of the global lock by the requesting process. According to an embodiment of the invention, the global lock has to be acquired by any process whose request to release its locking on any resource of the resources group was denied, in order for releasing of the resource to be granted.

Referring to the examples set forth in the previous drawings, the global lock may be a global lock such as global lock 230 of system 200, and/or the global lock of method 400. In the latter case, the condition of stage 840 is met when the requesting gets the global lock as described in relation to stage 440. It is noted that the global lock is the only global lock associated with the resource (and with its associated lock whose locking was attempted at stage 810), and is possibly shared by a group of locks used for the locking of multiple resources.

According to an embodiment of the invention, method 800 may include adding to a global data-structure a pending-process entry associated with the process, wherein the global data-structure includes pending-process entries of any process whose request to unlock any resource of the resources group for performing of any task was denied. The global data-structure may also include pending-process entries of any process whose request to access any resource of the resources group for performing of any task was denied (see, e.g., method 700).

It will be clear to a person who is of skill in the art that the pending-process entries of the different processes whose requests to unlock various resources of the resources group were denied, may be included in the global data-structure at different times.

For example, the adding may include enqueuing in a global queue a pending-process entry associated with the process, wherein the global queue queues pending-process entries of any process whose request to unlock any resource of the resources group for performing of any task was denied, and possibly also pending-process entries of any process whose request to access any resource of the resources group for performing of any task, was denied.

Once the global lock is locked, optional stage 850 may be carried out, which includes receiving another request to unlock the resource (checking if the resource is available for unlocking). Stage 860 includes attempting to unlock the resource, which may be implemented by running an atomic compare-and-exchange operation (ACE, potentially implementable as a “compare-and-swap” or a “compare-and-set” operation) by the lock, e.g. with values C=1 and E=0. In some embodiments this will test if the associated resource-associated data-structure is empty. If implemented as an ACE request, the parallel status in the lock is that the lock-associated value X is determined as a result of the ACE(1,0) operation.

According to an embodiment of the invention, the selecting of a pending-task entry from the resource-associated data structure in stage 870 is preceded by attempting to unlock the resource that is locked by the process (in stage 860), and is selectively carried out only if the attempt failed.

According to an embodiment of the invention, method 800 may include in stage 850 receiving a request to unlock the resource and in stage 860 attempting to unlock the resource by running an atomic compare-and-exchange operation by the lock which includes comparing a compare value included in the request to a lock-associated value that is indicative of the number of pending-task entries in the resource-associated data structure, wherein the result of the attempting depends on a result of the comparing.

It should be noted that, according to an embodiment of the invention, the checking if the resource may be unlocked is carried out by the lock in response to a request of the process, but rather by a checking of the process of a value of a contention status and/or the lock-associated value X. Stage 860 may include determining whether the lock-associated value X indicates that there are currently one or more pending-task entries pending in the resource-associated data-structure.

Stage 860 may be preceded by stage 855 of updating the lock-associated value X and/or the contention status. The updating of stage 855 may be implemented by the requesting process, or by another entity—such as by the lock or by a locks manager—e.g. in response to an instruction from the process. It is noted that in some embodiments of the invention, both lock-associated value X and contention status may be used. For example, one of these values may be used to indicate whether the resource is locked or not (and may be a binary value, for example), while the other may be used to indicate the number of pending-task entries in the lock-associated data-structure (possibly added with the locking process). For example, the updating of stage 855 may include decreasing the lock-associated value by one (X=X−1) and/or modifying the contention status associated with the resource from unavailable (or “locked”) to available (or “unlocked”). It is noted that stage 850 may also be carried out after stage 860 or concurrently to which, in other embodiments of the invention.

According to an embodiment of the invention, stage 860 and stage 855 of updating of the lock-associated value and/or of the contention status are carried out together, in an atomic uninterruptable operation (wherein updating of the lock-associated value X may follow, if unlocking is denied).

If the attempt to unlock the resource in stage 860 is successful (denoted as YES in 860 of the drawing) then stage 865 is carried out, which includes sending an approval indication to the requesting process (e.g. a MAY-UNLOCK value, a SUCCESS). The process may then unlock the resource—but is first expected to release the global lock (denoted 880). The sending of the approval in stage 865 may be followed by a releasing of the locking on the resource (denoted 890).

According to an embodiment of the invention, if the attempt to unlock the resource is successful, the method also includes updating the lock-associated value X. According to an embodiment of the invention, the updating may be carried out in the same atomic operation as the attempting (and especially the comparing, if implemented) of stage 860. According to an embodiment of the invention, the sending of stage 865 may also be carried out in the same atomic operation.

When the requesting process receives the approval of 865, it releases the global lock. The releasing of the global lock by the process may precede stage 865 and may follow it. The releasing of the global lock would however occur before the unlocking of the resource by the requesting process, because the global lock is required only until the unlocking of the resource (or, as will be demonstrated below, for selecting an entry from the resource-associated data-structure).

If a result of stage 860 is that the resource may not be unlocked (denoted as NO in 860) by the requesting process (e.g. because there are currently pending-task entries pending in the resource-associated data-structure), then stage 870 is carried out, selecting a pending-task entry from the resource-associated data structure associated with the resource. The selecting may be carried out by the requesting process, by the lock, or by another entity such as a locking manager.

Following the selecting of the pending-task entry, the process will release the global lock (denoted 880). Referring to the examples set forth in the previous drawings, stage 880 may include selecting the pending-task entry from a resource-associated data-structure such as resource-associated data-structure 220. According to an embodiment of the invention, the resource-associated data-structure may be a resource-associated queue, but this is not necessarily so, wherein the selecting is responsive to position of one or more pending-task entries in the queue.

Especially, the selecting may be responsive to the position of the pending-task entry in the resource-associated queue. For example, the selecting may be selection of the first or topmost pending-task entry pending in the queue. Generally, the selecting pertained to in stage 870 may be carried out according to one or more local data structure selection rules.

The method may continue with the releasing of the locking on the resource by the requesting process (denoted 895), in which case the process may continue to other tasks, end, wait, and so forth. However, according to an embodiment of the invention, the process does not directly release the locking on the resource, but rather method 800 continues with stage 890 of executing (or instructing execution) by the requesting process of content included in the selected pending-task entry, content pointed to in the pending-task entry, and/or execute according to such content.

For example, if the content of the selected pending-task entry is an indication of another process that added the pending-task entry to the resource-associated data-structure, then the execution of stage 890 may include indicating that this other process should get the lock. In another example, if the content of the selected pending-task entry includes instructions and/or content of a task to be performed, then the execution of stage 890 may include carrying out that task before releasing the lock. In such a case, stage 890 may be followed by reiteration of method 800 from stage 810 onwards.

In an example, at stage 860 it is determined if the lock-associated value X is equal to 0. If it is (YES in stage 860), then X was equal to 1 prior to the decrease of stage 850 (in such an implementation X=0 means that no other process waits or holds the lock) and therefore it will release the global lock corresponding to stage 870 and a SUCCESS value will be sent to it in stage 865. Continuing the same example, if the value of the lock-associated value X is greater than 0 (NO in stage 860), then X was greater than 1 prior to the increase of stage 850 (which in such an implementation means that at least one pending-task entry in pending in the resource-associated data-structure) and therefore selecting of a pending-task entry from the resource-associated data-structure (which may be, for example, the lock's waiting queue), and releasing of the global lock are required before the unlocking may be carried out.

In different embodiments of the invention, the pending-task entries included in the resource-associated data-structure may be implemented in different ways—pertaining both to system 200 and to method 800 and to the methods discussed below. In some embodiments of the invention, the pending-task entries (e.g. pending-task entries 222) may include, for example, an identifier of the process adding them to the resource-associated data-structure, a pointer to the process and/or to a location accessible by which, a pointer to a function that should be carried out when the respective entry is selected (e.g. for calling the process), and so forth.

Such a function may be implemented in various ways, and even in different ways by different processes in a single implementation. For example, the selection of the pending-task entry from the resource-associated data-structure may be followed by carrying out of the function pointed to in the pending-task entry and which may be stored, for example, in a dedicated database, look-up-table, etc. The function, upon its execution, may perform various tasks such as any one or more of the following: indicating to the process that the pending-task entry was selected (e.g. allowing it to perform the task or delegate it to another thread or process), and/or indicating to another process (e.g. the process currently finished utilizing the resource) which task should be performed (content of such a task—e.g. material to be written to a mass-storage device—may be stored in another database and may include further instructions).

It should be noted that method 800 may be reiterated for several processes and possibly also for several locks. The corresponding stages in any such two or more reiterations are not necessarily carried out in an orderly fashion. For example—if a first process is denied its request in stage 825 of a first iteration before the request of a second process is denied in a second iteration, the second process may nevertheless unlock the resource (at stage 895) in some situations before the first process will do so.

It should be noted that according to an embodiment of the invention, one or more instances of method 800 may be carried out in parallel to one or more instances of method 700. Also according to such an embodiment of the invention, the corresponding stages in any such two or more reiterations are not necessarily carried out in an orderly fashion.

Referring to all of methods 300, 400, 500, 600, 700, and 800, it is noted that any one or more of these methods may be implemented using one or more program storage devices readable by machine, tangibly embodying a program of instructions executable by the machine to perform such a method. If more than one of these methods is implemented on a single system, it is noted that the instructions for one of these methods may be tangibly embodied on a same group of one or more program storage devices used for tangibly embodying any one or more of the other methods, but this is not necessarily so. In an example, such a program storage device may be memory 260 of system 200, but this is not necessarily so. It is also noted that such program storage device may be removable from any system that may execute the respective method. For example, the program storage device may be a DVD or a portable flash drive that may be connected or inserted to a computer in order for the computer to execute the instructions stored therein.

In an example, a program storage device that readable by machine is disclosed, tangibly embodying a program of instructions executable by the machine to perform a method for controlling access to a resources group including multiple computer accessible resources, including the steps of: (a) receiving a plurality of requests for granting a respective plurality of processes access to at least one resource of the resources group for performing respective tasks; (b) denying a request out of the plurality of requests, when a resource-associated lock of a respective resource is locked; (c) for any process out of the plurality of processes whose request to access a respective resource was denied, attempting to acquire a global lock for the respective process and granting access to the respective resource for performing of the respective task only after the global lock was acquired for the respective process; (d) upon acquisition of a global lock for a process that is associated with the request, granting exclusive access to a resource-associated data structure and adding to the data structure a pending-task entry that is associated with the process; and (e) upon a releasing of the resource associated lock, selectively granting exclusive access to the resource for performing a task associated with the pending task entry.

According to an embodiment of the invention, the resource-associated data structure is a resource-associated queue that is associated with the resource, wherein the instructions tangibly embodied in the program storage device for the selective granting include instructions for selective granting the exclusive access to the resource in response to a position of the pending-task entry in the resource-associated queue.

According to an embodiment of the invention, the program instructions tangibly embodied in the program storage device further include instructions for enqueuing in a global queue a pending-process entry associated with the process, wherein the global queue queues pending-process entries of any process whose request to access any resource of the resources group for performing of any task was denied.

According to an embodiment of the invention, the program instructions tangibly embodied in the program storage device further include instructions for attempting to lock the resource by running by the lock an atomic compare-and-exchange operation that includes comparing: (a) a value indicated in a received request to access the resource, and (b) a lock-associated value indicative of the number of pending-task entries in the resource-associated data structure; wherein the result of the attempting depends on a result of the comparing.

According to an embodiment of the invention, the granting of the exclusive access to add the pending-task entry into the resource-associated data structure is preceded by attempting to lock the resource for the process, and is selectively carried out only if the attempt failed.

According to an embodiment of the invention, the instructions for the selective granting of the exclusive access to the resource for performing the task includes instructions for carrying out the selective granting after a releasing of the global lock by the process.

According to an embodiment of the invention, the program instructions tangibly embodied in the program storage device further include instructions for denying a releasing-request of a previously-permitted process to release the locking of the resource when the resource-associated data structure includes non-zero number of pending-task entries, wherein the global lock has to be acquired by any process whose releasing-request to release the locking of any resource of the resources group was denied, in order for the locking to be released.

According to an embodiment of the invention, the program instructions tangibly embodied in the program storage device further include instructions for enqueuing in a global queue a pending-process entry associated with the process, wherein the global queue queues pending-process entries of any process whose request to access any resource of the resources group for performing of any task was denied; wherein the selectively granting of the exclusive access to the resource follows a selecting of the pending-task entry from the resource-associated data-structure in response to a position in the global queue of a process-associated entry associated with the previously-permitted process whose releasing request was denied.

According to an embodiment of the invention, the program instructions tangibly embodied in the program storage device further include instructions for executing a function indicated in the pending-task entry after the selective granting of the exclusive access to the resource for performing of the task associated with the pending task entry.

It will be clear to a person who is of skill in the art that the instructions exemplified as embodied in the program storage device are provided as a clarifying example only, and instructions for implementing any of the stages of the various methods 300, 400, 500, 600, 700, and/or 800—and their respective variations as discussed above—may also be implemented (either in that program storage device or in others).

Returning again to FIG. 1, it is noted that system 200 may be regarded as an access control system for controlling access to a resources group 10 that includes multiple computer accessible resources. Referring to a specific resource 100 and to a process that attempts to access it, it should be noted that system 200 includes a lock 210 (which is associated with that specific resource 100) that is configured to selectively deny a request of a process to access the specific resource 100 when that resource 100 is locked. That lock 210 may also be configured to selectively allow the request of the process to access the resource when that resource 100 is not locked. According to an embodiment of the invention, that lock 210 does not always allow the request of the process to access the resource when that resource 100 is not locked, e.g. if it is not locked but there are pending-task entries pending in an associated resource-associated data-structure 220.

System 200 may also include one or more contention status managers 250, wherein at least one of the one or more contention status managers 250 is configured to update a contention status associated with that resource 100 upon acquisition of the global lock 230 by the process. It should be noted that the contention status manager 250 may be implemented as part of the lock 210, but this is not necessarily so. A single contention status manager 250 may be configured to manage (e.g. update) the contention statuses associated with multiple resources 100 of the resources group 10.

The global lock 230 may be configured to grant to the process exclusive access to add a pending-task entry into the resource-associated data structure 220 associated with the resource 100; wherein it should be noted that the global lock 230 has to be acquired by any process whose request to access any resource 100 of the resources group 10 for performing of any task was denied, in order for access thereto for performing the respective task to be granted.

The discussed lock 210 is further configured to selectively grant, following the adding of the pending task-entry into the resource-associated data structure 220, exclusive access to the resource 100 for performing a task associated with the pending task entry upon releasing of the resource associated lock 100 (also referred to as the locking release of the resource 100).

According to an embodiment of the invention, the resource-associated data structure 220 is a resource-associated queue that is associated with the resource, wherein the lock 210 is configured to selectively grant the access to the resource 100 in response to a position of the pending-task entry in the resource-associated queue 220.

According to an embodiment of the invention, system 200 includes memory 260 for storing global queue 240 that queues pending-process entries of any process whose request to access any resource 100 of the resources group 10 for performing of any task was denied. In an example, a pending-process entry associated with the discussed process may be enqueued in the global queue 240. It should be noted that the same (or one or more others) memory 260 may also store some or all of the resource-associated data-structures 220, and/or some of the resources 100 (if these are memory resources 100).

As aforementioned, according to an embodiment of the invention the lock 210 is an atomic lock that is configured to run an atomic compare-and-exchange operation that includes comparing: (a) a value indicated in a received request to access the resource, and (b) a lock-associated value indicative of the number of pending-task entries in the resource-associated data structure.

According to an embodiment of the invention, the lock 210 is configured to selectively grant exclusive access to the resource for performing the task after a releasing of the global lock 230 by the process.

According to an embodiment of the invention, the lock 210 is further configured to deny a releasing-request of a previously-permitted process to release the locking of the resource 100 when the resource-associated data structure 220 includes a non-zero number of pending-task entries, wherein the global lock has to be acquired by any process whose releasing-request to release the locking of any resource 100 of the resources group 10 was denied, in order for the locking to be released.

According to an embodiment of the invention, the global queue 240 further queues pending-process entries of any process whose request to access any resource 100 of the resources group 10 for performing any task was denied; wherein the lock 210 is further configured to selectively grant the exclusive access to the resource, following a selecting of the pending-task entry from the resource-associated data-structure, in response to a position in the global queue 240 of a process-associated entry associated with the previously-permitted process whose releasing request was denied.

According to an embodiment of the invention, system 200 includes a processor (e.g. processor 290) that is configured to execute, following the selective granting by the lock of the exclusive access to the resource for performing of the task associated with the pending task entry, a function indicated in the pending-task entry.

Referring to system 200, to methods 300, 400, 500, 600, 700, 800, and to the exemplary program storage device tangibly embodying program of instructions, it should be noted that while a single global lock was disclosed for each group of resources, in other embodiments more than a single global lock may be implemented for such a group of resources.

For example, different global locks may be used for different types of processes—or for processes attempting to access the resources for performing different types of actions. In but one example, it is noted that a different global lock may be implemented for reading operations other than the global lock that is implemented for writing operations.

It is noted that not only the global lock but also the locks associated with each of the resources may be used for different types of processes—or for processes attempting to access the resources for performing different types of actions. For example, some or all of these locks may be a readers-writer or shared-exclusive lock (also known by the name multi-reader lock). Such a readers-writer lock may be implemented similarly to a mutex, in that it controls access to some shared memory area, but it allows multiple threads to read from the shared area concurrently. Any thread that needs to write to the shared memory, of course, needs to acquire an exclusive lock.

The locks associated with the resources and/or the global lock—and the combination thereof—may be implemented in different ways in order to handle different problems associated with processes differentiations. For example, such implementations may be designed to overcome write-starvation problems, write biasing, and so forth.

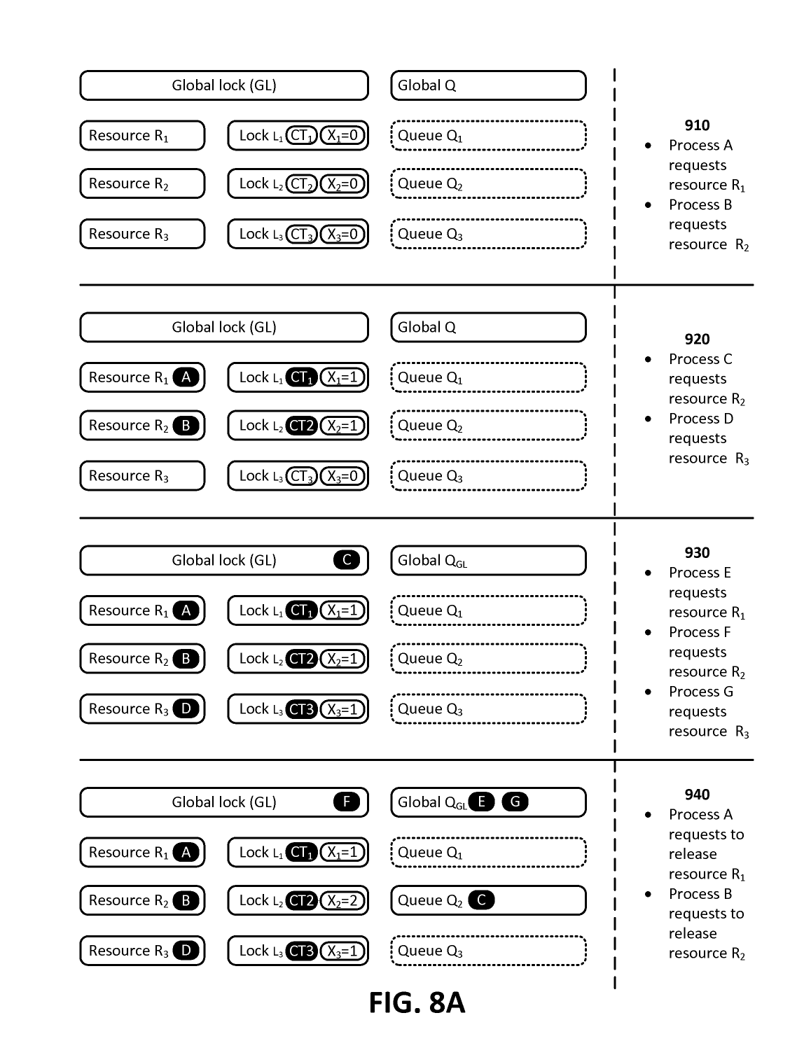

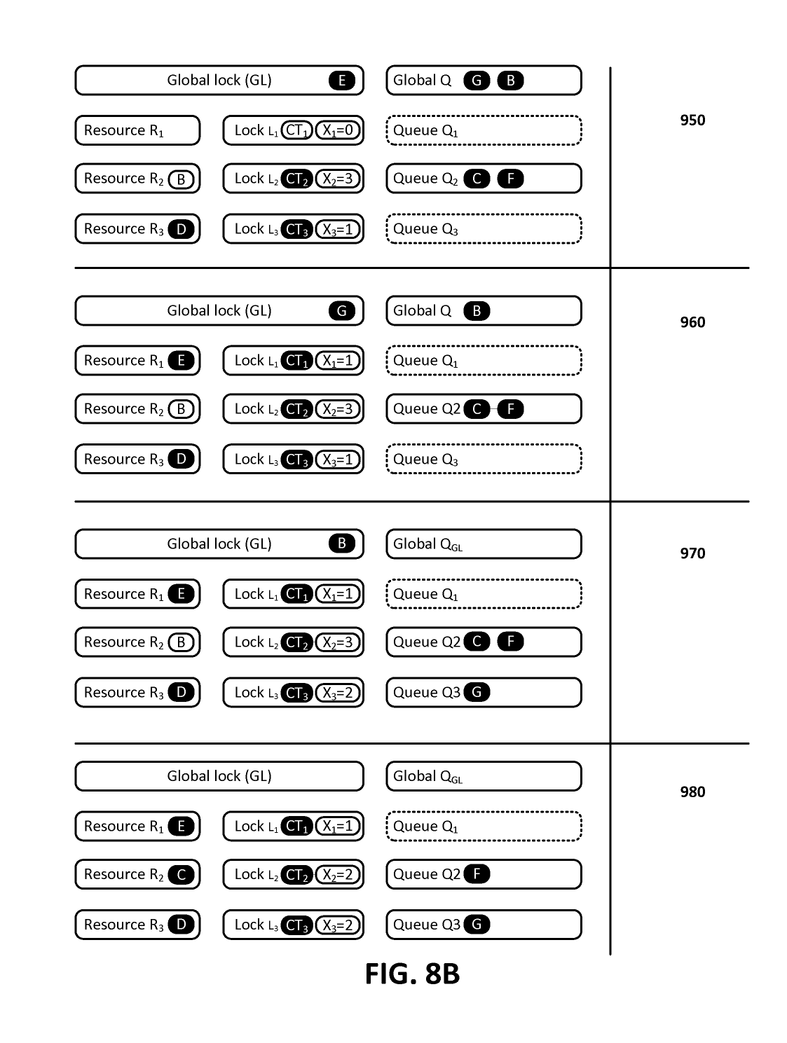

FIGS. 8A and 8B illustrate access control of multiple resources, according to an embodiment of the invention. The example 8 may clarify some implementations of both the system and methods discussed above.

Three resources are exemplified, even though the number of resources in any resources group implemented may well exceed three. These resources are denoted resource R₁, resource R₂, and resource R₃. At the start, none of these resources is busy. In the implementation illustrated, the resource-associated data-structure are implemented as queues Q₁, Q₂, and Q₃, respectively, that are only created when required. Since at the start none of the queues Q₁, Q₂, and Q₃ is required, they are not managed, nor do they occupy, a memory space (denoted by the dashed lines).

In a first time span 910, process A requests access to resource R₁ and process B requests access to process R₂. It is noted that each of the time spans illustrated may be a single clock duration of a processor executing the processes and/or the locks, or more than one clock duration. Also, the durations of the different time spans are not necessarily equal to each other.

In response to the requests, the lock-associated values X₁, and X₂, associated with the requested resources R₁, and R₂ are checked to determine whether access to the respective requested resources may be granted. Alternatively, the contention statuses CT₁, and CT₂, associated with the requested resources R₁, and R₂ may be checked. It should be noted that while both lock-associated values X and contention statuses CT are illustrated, in some given implementations only one type of these two is implemented.

Since the lock associated values X₁, and X₂, (as well as the contention statuses CT₁, and CT₂) indicate that access may be granted to both of those resources, both of the processes A and B are granted access to the requested resources R₁, and R₂. The contention statuses CT₁, and CT₂ are updated to indicated that the respective resources are locked (illustrated by the matching blacked out boxes in time span 920), and the lock associated values X₁, and X₂ are each increased by one.

In a second time span 920, process C requests access to resource R₂ and process D requests access to process R₃. In response to the requests, the lock-associated values X₂, and X₃, associated with the requested resources R₂, and R₃ are checked to determine whether access to the respective requested resources may be granted. Alternatively, the contention statuses CT₂, and CT₃, associated with the requested resources R₁, and R₂ may be checked.

The lock associated value X₃ (as well as the contention statuses CT₃) indicates that access may be granted to resource R₃, and therefore process D is granted access to the requested resource R₃. The contention status CT₃ is updated to indicate that the respective resource R₃ is locked, and the lock associated value X₃ is increased by one.

However, the lock associated value X₂ (as well as the contention statuses CT₂) indicates that access may not be granted to resource R₂, (as the latter is currently locked by process B) and therefore process C is denied access to the requested resource R₂. The contention status CT₂ may or may not be updated as a result.

However, process C cannot add a respective pending-task entry to the resource-associated queue Q₂, immediately, but rather has to get the global lock GL first. Since there are no pending-process entries pending in the global queue Q_{GL}, process C may immediately acquire the global lock GL, as shown in time span 930. In this time span, three additional processes E, F, and G are requesting access to resources R₁, R₂, and R₃ respectively. Since all of these resources are locked, the response to the requests by processes E, F, and G is similar to the response to the request of process C discussed above.

In time span 940, process C—which acquired the global lock, may add a respective pending-task entry to the respective queue Q₂, which is created at that time—when it is needed. For sake of convenience, the respective task-pending entry is also denoted C, even though, as aforementioned, it is not necessarily associated with process C (which may, for example, end or switch to another task). When the respective task entry is added to queue Q₂, the lock associated value X₂ may also be increased by one.

Of the processes E, F, and G, only one can get the global lock (e.g. process F), and therefore the other processes E and G are queued in the global queue Q_{GL}.

Also in time span 940, process A requests to release resource R₁, and process B requests to release resource R₂. Since, in the given example, the lock-associated value X₁ is not updated when the request of process E is denied, checking of the lock-associated value X₁ will give the result that process A may release resource R₁, as shown in time span 950. The contention status CT₁ will be updated accordingly, and the respective lock-associated value X₁ will be decreased by one.

However, checking of the lock-associated value X₂ will show that there is a pending-task entry pending in queue Q₂, and therefore process B may not release resource R₂, and has to first get the global lock GL according to the shown example. Since the global lock GL is taken, process B has to add a pending-process entry to the global queue Q_{GL}. The box of process B in resource R₂ is whitened, to indicate that it is no longer utilizing resource R₂ but is nevertheless prevented from unlocking it.

Process F that acquired the global lock GL added a respective pending-task entry to queue Q₂ (and the respective lock-associated value X₂ is increased by one accordingly), and therefore released the global lock GL, which may then be given to a process whose associated pending-process entry was selected from the global queue Q_{GL}, process E.

In time span 960, process E which got the global lock, may attempt to lock resource R₁, and since resource R₁ is not locked, it may lock it immediately, wherein the respective contention status and lock-associated value are updated accordingly, as discussed above in relation to process B, for example.

The next pending-process entry in the global queue QGL, process G is selected, and is given the global lock GL. It therefore attempts to lock resource R3, and since resource R3 is locked, it may not lock it immediately, and therefore it adds a pending-task entry to queue Q3, as shown in time span 970. The respective lock-associated value X3 is increased by one, accordingly. After that, process G releases the global lock, which may then be acquired by process B (as shown in time span 970), which attempts to unlock resource R2.

When process B attempts to unlock resource R₂, the attempt again fails—as the respective lock-associated value X₂ indicates that there are pending-task entries pending in the respective resource-associated queue Q₂. Therefore, process B does not release resource R₂ immediately, but rather first selects (or instructs a selection of) a pending-task entry out of the respective resource-associated queue Q₂, in this case the pending-task entry added by process C.

In the shown example, the pending-task entry calls process C, which is then permitted to lock resource R₂, and process B may continue to other tasks, etc. The respective lock-associated value X₂ is decreased by one, and the respective task-pending entry is removed from resource-associated queue Q₂, as shown in time span 980.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A method for controlling access to a resources group comprising multiple computer accessible resources, the method comprising:
receiving a plurality of requests for granting a respective plurality of processes access to at least one resource of the resources group for performing respective tasks;
denying a request out of the plurality of requests, when a resource-associated lock of a respective resource is locked;
for any process out of the plurality of processes whose request to access a respective resource was denied, attempting to acquire a global lock for the respective process and granting access to the respective resource for performing of the respective task only after the global lock was acquired for the respective process;
upon acquisition of a global lock for a process that is associated with the request, granting exclusive access to a resource-associated data structure and adding to the data structure a pending-task entry that is associated with the process; and
upon a releasing of the resource associated lock selectively granting exclusive access to the resource for performing a task associated with the pending task entry.

2. The method according to claim 1, wherein the resource-associated data structure is a resource-associated queue that is associated with the resource, wherein the selective granting is responsive to a position of the pending-task entry in the resource-associated queue.

3. The method according to claim 1, further comprising enqueuing in a global queue a pending-process entry associated with the process, wherein the global queue queues pending-process entries of any process whose request to access any resource of the resources group for performing of any task was denied.

4. The method according to claim 1, further comprising attempting to lock the resource by running by the lock an atomic compare-and-exchange operation that includes comparing: (a) a value indicated in a received request to access the resource, and (b) a lock-associated value indicative of the number of pending-task entries in the resource-associated data structure; wherein the result of the attempting depends on a result of the comparing.

5. The method according to claim 1, wherein the granting of the exclusive access to add the pending-task entry into the resource-associated data structure is preceded by attempting to lock the resource for the process, and is selectively carried out only if the attempt failed.

6. The method according to claim 1, wherein the selective granting of the exclusive access to the resource for performing the task is carried out after a releasing of the global lock by the process.

7. The method according to claim 1, further comprising denying a releasing-request of a previously-permitted process to release the locking of the resource when the resource-associated data structure comprises a non-zero number of pending-task entries, wherein the global lock has to be acquired by any process whose releasing-request to release the locking of any resource of the resources group was denied, in order for the locking to be released.

8. The method according to claim 7, further comprising:
enqueuing in a global queue a pending-process entry associated with the process, wherein the global queue queues pending-process entries of any process whose request to access any resource of the resources group for performing of any task was denied;
wherein the selective granting of the exclusive access to the resource follows a selecting of the pending-task entry from the resource-associated data-structure in response to a position in the global queue of a process-associated entry associated with the previously-permitted process whose releasing request was denied.

9. The method according to claim 1, wherein the selective granting of the exclusive access to the resource for performing of the task associated with the pending task entry is followed by executing a function indicated in the pending-task entry.

10. An access control system for controlling access to a resources group comprising multiple computer accessible resources, the system comprising:
a lock, configured to selectively deny a request of a process to access the resource when the resource is locked; and
a global lock, configured to grant to the process exclusive access to add a pending-task entry into a resource-associated data structure associated with the resource; wherein the global lock has to be acquired by any process whose request to access any resource of the resources group for performing of any task was denied, in order for access thereto for performing the respective task to be granted;
wherein the lock is further configured to selectively grant, following the adding of the pending task-entry into the resource-associated data structure, exclusive access to the resource for performing a task associated with the pending task entry upon a releasing of the resource associated lock.

11. The system according to claim 10, wherein the resource-associated data structure is a resource-associated queue that is associated with the resource, wherein the lock is configured to selectively grant the access to the resource in response to a position of the pending-task entry in the resource-associated queue.

12. The system according to claim 10, further comprising a memory for storing a global queue that queues pending-process entries of any process whose request to access any resource of the resources group for performing of any task was denied, wherein a pending-process entry associated with the process may be enqueued in the global queue.

13. The system according to claim 10, wherein the lock is an atomic lock that is configured to run an atomic compare-and-exchange operation that includes comparing: (a) a value indicated in a received request to access the resource, and (b) a lock-associated value indicative of the number of pending-task entries in the resource-associated data structure.

14. The system according to claim 10, wherein the lock is configured to selectively grant the exclusive access to the resource for performing of the task after a releasing of the global lock by the process.

15. The system according to claim 10, wherein the lock is further configured to deny a releasing-request of a previously-permitted process to release the locking of the resource when the resource-associated data structure comprises non-zero number of pending-task entries, wherein the global lock has to be acquired by any process whose releasing-request to release the locking of any resource of the resources group was denied, in order for the locking to be released.

16. The system according to claim 15, wherein the global queue further queues pending-process entries of any process whose request to access any resource of the resources group for performing of any task was denied; wherein the lock is further configured to selectively grant the exclusive access to the resource, following a selecting of the pending-task entry from the resource-associated data-structure, in response to a position in the global queue of a process-associated entry associated with the previously-permitted process whose releasing request was denied.

17. The system according to claim 10, comprising a processor that is configured to execute, following the selective granting by the lock of the exclusive access to the resource for performing of the task associated with the pending task entry, a function indicated in the pending-task entry.

18. A program storage device readable by machine, tangibly embodying a program of instructions executable by the machine to perform a method for controlling access to a resources group comprising multiple computer accessible resources, comprising the steps of:
receiving a plurality of requests for granting a respective plurality of processes access to at least one resource of the resources group for performing respective tasks;
denying a request out of the plurality of requests, when a resource-associated lock of a respective resource is locked;
for any process out of the plurality of processes whose request to access a respective resource was denied, attempting to acquire a global lock for the respective process and granting access to the respective resource for performing of the respective task only after the global lock has been acquired for the respective process;
upon acquisition of a global lock for a process that is associated with the request, granting exclusive access to a resource-associated data structure and adding to the data structure a pending-task entry that is associated with the process; and
upon a releasing of the resource associated lock selectively granting exclusive access to the resource for performing a task associated with the pending task entry.

19. The program storage device according to claim 18, wherein the resource-associated data structure is a resource-associated queue that is associated with the resource, wherein the instructions tangibly embodied in the program storage device for the selective granting include instructions for selective granting the exclusive access to the resource in response to a position of the pending-task entry in the resource-associated queue.

20. The program storage device according to claim 18, wherein the program instructions tangibly embodied in the program storage device further include instructions for enqueuing in a global queue a pending-process entry associated with the process, wherein the global queue queues pending-process entries of any process whose request to access any resource of the resources group for performing of any task was denied.

21. The program storage device according to claim 18, wherein the program instructions tangibly embodied in the program storage device further Z for attempting to lock the resource by running by the lock an atomic compare-and-exchange operation that includes comparing: (a) a value indicated in a received request to access the resource, and (b) a lock-associated value indicative of the number of pending-task entries in the resource-associated data structure; wherein the result of the attempting depends on a result of the comparing.

22. The program storage device according to claim 18, wherein the granting of the exclusive access to add the pending-task entry into the resource-associated data structure is preceded by attempting to lock the resource for the process, and is selectively carried out only if the attempt failed.

23. The program storage device according to claim 18, wherein the instructions for the selective granting of the exclusive access to the resource for performing the task include instructions for carrying out the selective granting after a releasing of the global lock by the process.

24. The program storage device according to claim 18, wherein the program instructions tangibly embodied in the program storage device further include instructions for denying a releasing-request of a previously-permitted process to release the locking of the resource when the resource-associated data structure comprises a non-zero number of pending-task entries, wherein the global lock has to be acquired by any process whose releasing-request to release the locking of any resource of the resources group was denied, in order for the locking to be released.

25. The program storage device according to claim 24, wherein the program instructions tangibly embodied in the program storage device further include instructions for:
enqueuing in a global queue a pending-process entry associated with the process, wherein the global queue queues pending-process entries of any process whose request to access any resource of the resources group for performing of any task was denied;
wherein the selectively granting of the exclusive access to the resource follows a selecting of the pending-task entry from the resource-associated data-structure in response to a position in the global queue of a process-associated entry associated with the previously-permitted process whose releasing request was denied.

26. The program storage device according to claim 18, wherein the program instructions tangibly embodied in the program storage device further include instructions for executing a function indicated in the pending-task entry after the selective granting of the exclusive access to the resource for performing of the task associated with the pending task entry.
